(19) United States
(12) Patent Application Publication
(10) Pub. No.: US 2010/0277669 A1
(43) Pub. Date: Nov. 4, 2010

(54) ILLUMINATING DEVICE AND LIQUID CRYSTAL DISPLAY DEVICE

(75) Inventors: Masaya Adachi, Hitachi (JP); Tatsuya Sugita, Takahagi (JP); Chieko Araki, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/769,822

(22) Filed: Apr. 29, 2010

(30) Foreign Application Priority Data
May 1, 2009 (JP) 2009-112219

(51) Int. Cl. G02F 1/1335; F21V 7/04

(52) U.S. Cl. 349/62; 362/606

(57) ABSTRACT

Provided is an illuminating device (1) including: a light source (10); a light-guide-plate (20) received light from the light source at a side surface of the light-guide-plate and outputting from a front surface of the light-guide-plate; and reflector (30) disposed on a rear surface side of the light-guide-plate. The light-guide-plate outputs light having a peak of a luminance at an output angle inclined with respect to a normal line of the front surface. A part of the light output at the angle is made obliquely incident on the front surface at an angle smaller than a critical angle to be reflected in the light-guide-plate and, then, when the part of the light obliquely travels to the rear surface and to return to the front surface, polarized light components are converted so as to contain more p-polarized light components than s-polarized, and the part of the light is output.

### CROSS-REFERENCE TO RELATED APPLICATION

The present application claims priority from Japanese application JP 2009-112219 filed on May 1, 2009, the content of which is hereby incorporated by reference into this application.

### BACKGROUND OF THE INVENTION

1. Field of the Invention

The present invention relates to an illuminating device which includes a light guide plate, and more particularly, to a display device which includes the illuminating device as a backlight.

2. Description of the Related Art

A display device is one of media for visually conveying information to people. In today's advanced information society, the display device has become a material tool for people as well as in society. Specifically, the liquid crystal display device has been dramatically improved in recent years in its performance, and is employed as a display device for a cellphone, a personal computer, a large screen TV, or the like. The typical liquid crystal display device includes a liquid crystal display panel and a backlight (illuminating device) which is placed behind the liquid crystal display panel in order to irradiate light onto the liquid crystal display panel.

The liquid crystal display panel adjusts a transmission of light of light emitted from the backlight, to thereby display an image on the liquid crystal display panel. A desired liquid crystal display panel includes a polarizer and controls a polarization state of light incident on a liquid crystal layer to display an image because the image that has a high contrast ratio may be obtained with a relatively low driving voltage. The above-mentioned liquid crystal display panel may be, for example, a twisted nematic (TN) display panel, a super twisted nematic (STN) display panel, or an electrical controlled birefringence (ECB) display panel. Alternatively, the liquid crystal display panel may be an in-plane switching (IPS) display panel or a vertical aligned (VA) display panel, which features a wide viewing angle. In any one of the above-mentioned display panels, the liquid crystal display panel includes a pair of transparent substrates, a liquid crystal layer which is sandwiched between the pair of transparent substrates, and a pair of polarizers, each of which is disposed on a surface of each of the transparent substrates opposite to the liquid crystal layer, and the polarization state of light incident on the liquid crystal layer is changed to control the transmission of light, to thereby display the image.

The polarizer has functions of absorbing predetermined linearly polarized light components and allowing another linearly polarized light which has a polarization plane orthogonal to the predetermined linearly polarized light, to pass through the polarizer. Therefore, when light irradiated onto the liquid crystal display panel is unpolarized light, the polarizer of the liquid crystal display panel absorbs at least 50% of the illuminating light. That is, in the liquid crystal display device, when the light emitted from the backlight is unpolarized light, about a half of the illuminating light is absorbed by the polarizer to be lost. In view of the above, it is important to reduce a ratio of the illuminating light from the backlight that is absorbed by the polarizer of the liquid crystal display panel in order to realize a liquid crystal display device capable of providing a brighter image or achieving a lower power consumption.

Examples of the backlight of the liquid crystal display device include an edge light type backlighting system (light guide plate type backlighting system), a direct type backlighting system (reflector plate type backlighting system), and the like. Among those, the edge light type backlighting system is utilized in order to reduce the thickness of the backlighting system.

The backlight of the edge light type backlighting system includes a planar transparent plate which is called light guide plate, a linear or point light source provided at an edge of the light guide plate, an optical sheet, which is called prism sheet, for adjusting a traveling angle of light output from the light guide plate, a diffusion sheet, and the like. The light guide plate includes a function of diffusing light from the light source in a planar direction. The light output from the light guide plate normally has a maximum value (peak) of a luminance or a luminous intensity in a direction inclined at an angle between 60 and 80 degrees with respect to a direction of a vertical line (normal line) of the light outputting surface (surface) of the light guide plate. It is known that light which is output from the light guide plate at an angle (peak angle) at which the luminance or the luminous intensity becomes the maximum value contains more p-polarized light components than s-polarized light components.

In Japanese Patent Application Laid-open No. 10-20125, there is disclosed a surface light source device which increases, by providing a high refractive index layer on a surface of a light guide plate, a difference in reflectance between p-polarized light and s-polarized light and further increases a ratio of p-polarized light components. In Japanese Patent Application Laid-open No. 10-20125, it is also described that a phase difference plate of having an optical axis of 45 degrees is provided on a front surface side (light outputting surface side) or a rear surface side of the light guide plate, so as to cause polarization conversion to occur, to thereby further increase the ratio of p-polarized light components. In this case, illuminating light output from the illuminating device contains polarized light, and hence the use of the illuminating light for the backlight of the liquid crystal display device enables improvement in light utilization efficiency.

It is known that light output from a light guide plate normally has an angle (peak angle) at which a luminance or a luminous intensity becomes the maximum value in a direction inclined at an angle of a range between 60 and 80 degrees with respect to a direction of a vertical line (normal line) of a light outputting surface of the light guide plate, and light output at the peak angle or any angle in a range near the peak angle contains more p-polarized light components than s-polarized light components. This is attributed to a difference of a transmittance between the p-polarized light components and the s-polarized light components at an interface between the light guide plate and air.

For example, in a light guide plate constituted of a transparent medium having a refractive index of 1.57, a study is made on light output from a surface (light outputting surface) of the light guide plate at an angle of 76 degrees (angle with respect to a direction of a vertical line (normal line) of the light outputting surface of the light guide plate). In calculation, unpolarized light within the light guide plate exits from the light guide plate as light having a degree of polarization of 23% with respect to p-polarized light.

A degree of polarization ρ is represented by the following expression (1), where Imax indicates a maximum luminance and Imin indicates a minimum luminance which are obtained by measuring a luminance of light output from the light guide plate or the prism sheet through an analyzer while rotating the analyzer (polarizer):

[Expression 1]

ρ=(Imax−Imin)/(Imax+Imin) (1)

In this specification, a degree of polarization ρp for p-polarized light (degree of polarization of p-polarized light) is specifically defined by the following expression (2), where Ipmax indicates a luminance when an absorption axis of the analyzer and p-polarized light are orthogonal to each other and Ipmin indicates a luminance of light when the absorption axis and the p-polarized light are parallel to each other:

[Expression 2]

ρp=(Ipmax−Ipmin)/(Ipmax+Ipmin) (2)

In actual measurement, however, a degree of polarization of the p-polarized light is about 14%, which is lower than 23% or a value in the calculation. The inventors of the present invention considered that this may be because light reflected on an interface between air and the light guide plate to return into the light guide plate contains fewer p-polarized light components but more s-polarized light components, contrary to output light. In other words, in reality, light propagating through the light guide plate contains more s-polarized light components than p-polarized light components, as compared with a case where the light propagating through the light guide plate is assumed to be unpolarized light containing p-polarized light components and s-polarized light components equal in ratio. Hence, the light output from the light guide plate has a degree of polarization of p-polarized light lower than the calculation value. Thus, in order to improve a degree of polarization of p-polarized light of the light output from the light guide plate, the inventors considered that it may be effective to efficiently converts-polarized light propagating through the light guide plate into p-polarized light. Conventionally, a study has been conducted on the possibility of causing polarization conversion by providing a phase difference plate having an optical axis (slow axis) of 45 degrees on the front surface (light outputting surface) or on the rear surface of the light guide plate, to thereby further increase a ratio of p-polarized light components.

The inventors of the present invention studied about a birefringence to perform efficient polarization conversion in the light guide plate. Specifically, assuming a model illustrated in FIG. 5, the inventors evaluated how much s-polarized light propagating from a front surface 24 side to a rear surface 25 side in the light guide plate 20 was converted into p-polarized light when the s-polarized light was reflected on the rear surface 25 and by reflector 30 to return to the front surface 24. This is an evaluation made on how intensity of p-polarized light increases in light which has started from the front surface 24 of the light guide plate in a state of intensity of p-polarized light of 0 and is reflected on the rear surface 25 and by the reflector 30 to return to the front surface 24. When intensity of p-polarized light is 1, it means that the s-polarized light has completely been converted into p-polarized light. The intensity of p-polarized light is an index regarding a light intensity of p-polarized light.

FIG. 31 illustrates a relationship between a traveling angle (polar angle β) of light and intensity of p-polarized light in the case of the conventional technology, that is, in a case where the light guide plate has a birefringence of a slow axis angle of 45 degrees (or 135 degrees) and a phase difference of quarter wavelength. An angle of the slow axis is defined as 0 degrees in the longitudinal direction of a light incident surface anticlockwise. In this case, a main traveling angle of light propagating through the light guide plate is 90 degrees, and the light guide plate is made of a transparent medium having a refractive index of 1.57. As illustrated in FIG. 31, when a slow axis of a phase difference plate provided in the light guide plate is 45 degrees, highly efficient polarization conversion may be performed with intensity of p-polarized light exceeding 0.95 from an inclination angle (polar angle) of β=0 degrees to about 25 degrees with respect to a normal line direction of the light outputting surface of the light guide plate. However, light for which a high degree of polarization may be obtained when actually output from the light guide plate is light whose traveling angle range through the light guide plate is a range of from polar angles β=35 degrees to 39 degrees. This range of from polar angles β=35 degrees to 39 degrees is smaller than a critical angle, and close to Brewster' s angle which is about 33 degrees, resulting in an enlarged difference in reflectance between s-polarized light and p-polarized light. In other words, among traveling angles of light through the light guide plate, a range of angles to be considered in order to improve light utilization efficiency by obtaining high intensity of p-polarized light in an illuminating device is the above angle range (35 degrees to 39 degrees). The conventional technology has given no adequate consideration to light propagating within this angle range. Thus, as illustrated in FIG. 31, in the range of light traveling angles equal to or larger than the polar angle β=38 degrees, a low intensity of p-polarized light of equal to or smaller than 0.4 is obtained, and hence polarization conversion cannot be performed with high efficiency.

### SUMMARY OF THE INVENTION

The present invention has been made in consideration of the above-mentioned problems, and an object of the present invention is therefore to provide a light guide plate which may efficiently increase a degree of polarization (that is, efficiently increase a ratio of the p-polarized light components) of the light output from the light guide plate, and to provide an illuminating device which may output illuminating light containing predetermined linearly polarized light components of high light intensity. Another object of the present invention is to realize a liquid crystal display device, which may provide a sufficient brightness but require less power consumption, by using the above-mentioned illuminating device. Further objects, problems, and inventive features of the present invention are described below in detail with reference to the description of the specification and the attached drawings.

(1) in order to solve the above-mentioned problems, the present invention provides an illuminating device including: a light source; a light guide plate received a light from the light source at a side surface of the light guide plate and outputting from a front surface of the light guide plate; and a reflector disposed on a rear surface side of the light guide plate, wherein the light guide plate outputs light so that the light has a peak of one of a luminance and luminous intensity at an output angle inclined with respect to a normal line of the front surface, wherein the light guide plate has a birefringence, and wherein a part of the light output at the output angle is made obliquely incident on the front surface at an angle smaller than a critical angle on the front surface of the light guide plate to be reflected in the light guide plate and, then, when the part of the light travels to the rear surface side and is reflected on the rear surface side of the light guide plate and on the reflector to return to the front surface, the part of the light has polarized light components converted so that the part of the light contains more p-polarized light components than s-polarized light components, and the part of the light is output from the front surface.

(2) In the illuminating device according to (1), wherein the light source causes the light to be incident from the side surface of the light guide plate so that the light propagates through the light guide plate, wherein the rear surface of the light guide plate has a plurality of inclined surface portions having minute inclined surfaces inclined at predetermined angles formed thereon, and wherein the plurality of inclined surface portions reflect the light propagating through the light guide plate so as to be made incident on the front surface at angles smaller than the critical angle.

(3) The illuminating device according to (2), wherein the reflector comprises a reflective member formed into a layer shape, wherein the light guide plate and the reflective member has a transparent medium formed so as to be interposed therebetween, and wherein the light guide plate has a birefringence according to a thickness and a refractive index of the transparent medium.

(4) The illuminating device according to (3), wherein the transparent medium comprises a transparent member having a refractive index lower than a refractive index of the light guide plate and higher than a refractive index of air.

(5) The illuminating device according to (4), wherein the refractive index of the transparent member is 1.3 or more to 1.45 or less.

(6) The illuminating device according to (3), wherein the light source contains light with a wavelength of λ, and wherein the light guide plate has an optical anisotropy, and has the birefringence set so that an angle θ formed between a slow axis of the light guide plate and a longitudinal direction of the side surface having the light source of the light guide plate disposed therein is larger than 45 degrees or that a phase difference R of the light guide plate is larger than λ/4.

(7) The illuminating device according to (5), wherein the light source contains light with a wavelength of λ, and wherein the light guide plate has an optical anisotropy, an angle θ formed between a slow axis of the light guide plate and a longitudinal direction of the side surface having the light source of the light guide plate disposed therein is 44°≦θ≦59°, and a phase difference R of the light guide plate satisfies λ/4×0.98≦R≦λ/4×1.08.

(8) The illuminating device according to (7), wherein the light guide plate is configured so that an angle θ formed between the slow axis of the light guide plate and a longitudinal direction of the side surface having the light source of the light guide plate disposed therein is 50°≦θ≦53°, and the phase difference R of the light guide plate satisfies λ/4×1.025≦R≦λ/4×1.033.

(9) The illuminating device according to (8), wherein the angle θ formed between the slow axis of the light guide plate and the longitudinal direction of the side surface having the light source of the light guide plate formed therein is 52°, and the phase difference R satisfies λ/4×1.025≦R≦λ/4×1.033.

(10) The illuminating device according to (3), wherein the transparent medium comprises air having a refractive index of about 1.0, and wherein the reflective member and the rear surface of the light guide plate have a space formed therebetween by the transparent medium.

(11) The illuminating device according to (10), wherein the space has a thickness of 50 nm or more to 240 nm or less.

(12) The illuminating device according to (11), wherein the light source contains light with a wavelength of λ, and wherein the light guide plate has a uniaxial anisotropy, an angle θ formed between a slow axis of the light guide plate and a longitudinal direction of the side surface having the light source of the light guide plate disposed therein is 64°≦θ≦71′, and a phase difference R of the light guide plate satisfies λ/4×1.35≦R≦λ/4×1.75.

(13) The illuminating device according to (10), wherein the plurality of inclined surface portions are formed into concave shapes from the rear surface of the light guide plate, wherein at least one spacer is formed on the rear surface of the light guide plate so as to maintain the space between the light guide plate and the reflective member, and wherein the spacer is disposed adjacent to one of the plurality of inclined surface portions and on a side opposite to a side having the light source disposed thereon with respect to the inclined surface portion.

(14) The illuminating device according to (10), wherein the plurality of inclined surface portions are formed into convex shapes from the rear surface of the light guide plate, wherein at least one spacer is formed on the rear surface of the light guide plate so as to maintain the space between the light guide plate and the reflective member, and wherein the spacer is disposed adjacent to one of the plurality of inclined surface portions and on a side having the light source disposed thereon with respect to the inclined surface portion.

(15) The illuminating device according to (2), wherein the reflector comprises a reflective member contacted to the rear surface of the light guide plate and formed into a layer shape.

(16) The illuminating device according to (10), wherein the space has a thickness of 30 nm or less.

(17) The illuminating device according to one of (15) and (16), wherein the light source contains light with a wavelength of λ, and wherein the light guide plate has a uniaxial anisotropy, an angle θ formed between a slow axis of the light guide plate and a longitudinal direction of the side surface having the light source of the light guide plate disposed therein is 43°≦θ≦60°, and a phase difference R of the light guide plate satisfies λ/4×0.9≦R≦λ/4×1.2.

(18) The illuminating device according to (17), wherein the light guide plate is configured so that the angle θ formed between the slow axis of the light guide plate and the longitudinal direction of the side surface having the light source of the light guide plate disposed therein is 50, and the phase difference R of the light guide plate satisfies λ/4×0.96≦R≦λ/4×1.08.

(19) The illuminating device according to (18), wherein the angle θ formed between the slow axis of the light guide plate and the longitudinal direction of the side surface having the light source of the light guide plate formed therein is 52°, and the phase difference R of the light guide plate satisfies λ/4×1.025.

(20) The illuminating device according to (2), wherein the light guide plate comprises: a thin plate-shaped transparent medium having a birefringence; and a high refractive index material having a refractive index higher than a refractive index of the transparent medium, and wherein the front surface of the light guide plate is configured by forming the high refractive index material into a layer shape on the thin plate-shaped transparent medium.

(21) The illuminating device according to (20), wherein the light source contains light with a wavelength of λ, and wherein the high refractive index material has a thickness and a refractive index according to the light with the wavelength of λ output at the output angle from the front surface of the light guide plate.

(22) The illuminating device according to (2), wherein the illuminating device further comprises an optical sheet disposed on the front surface side of the light guide plate, wherein the optical sheet includes a base material formed of a transparent medium generating no phase difference for p-polarized light output from the light guide plate at the output angle to be made incident on a surface on the light guide plate side at a predetermined incident angle, and wherein one of the surface of the optical sheet on the light guide plate side and a surface on an opposite side of the light guide plate includes a prism array having at least two inclined surfaces and a ridge line parallel to a longitudinal direction of the side surface having the light source of the light guide plate disposed therein.

(23) The illuminating device according to (22), wherein the transparent medium forming the base material of the optical sheet has a slow axis which is one of substantially parallel to and substantially orthogonal to a ridge line direction of the prism array.

(24) The illuminating device according to (22), wherein the transparent medium forming the base material of the optical sheet has a biaxial anisotropy, and the transparent medium has a slow axis which is one of substantially parallel to and substantially orthogonal to a ridge line direction of the prism array.

(25) The illuminating device according to (22), wherein the optical sheet includes the prism array disposed on the surface on the opposite side of the light guide plate, and wherein the surface of the base material on the light guide plate side includes s-polarized light high reflecting means for increasing, for light output from the light guide plate to be made incident on the surface on the light guide plate side at a predetermined angle, a ratio of the p-polarized light components of the light transmitted through the optical sheet by reflecting the s-polarized light components of the light.

(26) The illuminating device according to (25), wherein the s-polarized light high reflecting means includes a layer of a transparent material having a thickness according to the output angle and a refractive index higher than a refractive index of the base material of the optical sheet.

(27) In order to solve the above-mentioned problems, the present invention provides a liquid crystal display device including: an illuminating device; and a liquid crystal display panel for displaying an image by controlling a transmission of light from the illuminating device, wherein the illuminating device comprises: a light source; a light guide plate received a light from the light source at a side surface of the light guide plate and outputting from a front surface of the light guide plate; and a reflector disposed on a rear surface side of the light guide plate, wherein the light guide plate outputs light so as to have a peak of one of a luminance and luminous intensity at an output angle inclined by a predetermined angle with respect to a normal line of the front surface, wherein the light guide plate has a birefringence, wherein apart of the light output at the output angle is made obliquely incident on the front surface at an angle smaller than a critical angle on the front surface of the light guide plate to be reflected in the light guide plate and, then, when the part of the light obliquely travels from the front surface through the light guide plate via the reflector to return, polarized light components are converted so as to contain more p-polarized light components than s-polarized light components, and the part of the light is output from the front surface at the output angle, and wherein the liquid crystal display panel comprises a polarizer disposed on the illuminating device side, the polarizer having a transmission axis provided in parallel to the p-polarized light components of the light output at the output angle.

According to the present invention, an illuminating device which outputs illuminating light with a high light intensity of linearly polarized light components may be realized. Further, by using the illuminating device, a liquid crystal display device which may provide sufficient brightness but requires less power consumption may be realized.

### BRIEF DESCRIPTION OF THE DRAWINGS

In the accompanying drawings:

FIG. 1 is a cross sectional view illustrating a main configuration of an illuminating device according to an embodiment of the present invention;

FIG. 2 is a plan view schematically illustrating the configuration of the illuminating device according to the embodiment of the present invention;

FIG. 3 is a schematic cross sectional view illustrating a part of a sectional structure of the illuminating device according to the embodiment of the present invention;

FIG. 4 is an explanatory view illustrating a slow axis angle of a light guide plate;

FIG. 5 is a partial cross sectional view illustrating the light guide plate and reflector in the illuminating device according to the embodiment of the present invention;

FIG. 6 is a graph illustrating a relationship between a thickness d air of a space between the light guide plate and the reflector and intensity of p-polarized light in the illuminating device according to the embodiment of the present invention;

FIG. 7 is a view illustrating a part of a sectional structure of the light guide plate and the reflector in the illuminating device according to the embodiment 1 of the present invention;

FIG. 8 is a graph illustrating a relationship between a traveling angle β of light propagating through the light guide plate and intensity of p-polarized light in the illuminating device according to the embodiment) of the present invention;

FIG. 9 is a graph illustrating a relationship between a slow axis angle of the light guide plate and intensity of p-polarized light in the illuminating device according to the embodiment 1 of the present invention;

FIG. 10 is a graph illustrating a relationship between a phase difference of the light guide plate and intensity of p-polarized light in the illuminating device according to the embodiment 1 of the present invention;

FIG. 11 is a partial cross sectional view illustrating a structure of the light guide plate and the reflector in the illuminating device according to the embodiment 2 of the present invention;

FIG. 12 is a partial cross sectional view illustrating a structure of the light guide plate and the reflector in the illuminating device according to the embodiment 2 of the present invention;

FIG. 13 is a graph illustrating a relationship between a traveling angle β of light propagating through the light guide plate and intensity of p-polarized light in the illuminating device according to the embodiment 2 of the present invention;

FIG. 14 is a graph illustrating a relationship between a thickness d air of a space between a rear surface of the light guide plate and the reflector and intensity of p-polarized light in the illuminating device according to the embodiment 2 of the present invention;

FIG. 15 is a graph illustrating a relationship between a slow axis angle θ of the light guide plate and intensity of p-polarized light in the illuminating device according to the embodiment 2 of the present invention;

FIG. 16 is a graph illustrating a relationship between a phase difference of the light guide plate and intensity of p-polarized light in the illuminating device according to the embodiment 2 of the present invention;

FIG. 17 is a view illustrating a part of a sectional structure of the light guide plate and the reflector in the illuminating device according to the embodiment 3 of the present invention;

FIG. 18 is a graph illustrating a relationship between a traveling angle β of light propagating through the light guide plate and intensity of p-polarized light in the illuminating device according to the embodiment 3 of the present invention;

FIG. 19 is a graph illustrating a relationship between a slow axis angle θ of the light guide plate and p-polarized light in the illuminating device according to the embodiment 3 of the present invention;

FIG. 20 is a graph illustrating a relationship between a phase difference of the light guide plate and intensity of p-polarized light in the illuminating device according to the embodiment 3 of the present invention;

FIG. 21 is a graph illustrating a relationship between a thickness of a transparent member interposed between the rear surface of the light guide plate and the reflector and intensity of p-polarized light in the illuminating device according to the embodiment 3 of the present invention;

FIG. 22 is a graph illustrating a relationship between a traveling angle β of light propagating through the light guide plate and intensity of p-polarized light in the illuminating device according to the embodiment 3 of the present invention;

FIG. 23 is a graph illustrating a relationship between a slow axis angle θ of the light guide plate and intensity of p-polarized light in the illuminating device according to the embodiment 3 of the present invention;

FIG. 24 is a graph illustrating a relationship between a phase difference of the light guide plate and intensity of p-polarized light in the illuminating device according to the embodiment 3 of the present invention;

FIG. 25 is a graph illustrating a relationship between a thickness of a transparent member of the light guide plate and intensity of p-polarized light in the illuminating device according to the embodiment 3 of the present invention;

FIG. 26 is a graph illustrating a relationship between a distance from the rear surface of the light guide plate to the reflector and intensity of p-polarized light in the illuminating device according to the embodiment 3 of the present invention;

FIG. 27 is a schematic cross sectional view illustrating a part of the illuminating device according to the embodiment of the present invention;

FIG. 28 is a cross sectional view illustrating a shape of a prism formed on a front surface of a prism sheet according to the embodiment of the present invention;

FIG. 29 is a view illustrating an example of a transmittance calculation result of p-polarized light at a polar angle α=76 degrees when the p-polarized light is incident on a biaxial anisotropic transparent medium;

FIG. 30 is a cross sectional view illustrating a schematic structure of a liquid crystal display device according to an embodiment of the present invention; and

FIG. 31 is a graph illustrating a relationship between a traveling angle β of light propagating through a light guide plate and intensity of p-polarized light in an illuminating device according to a conventional technology.

### DETAILED DESCRIPTION OF THE INVENTION

Main configurations of an illuminating device according to an embodiment of the present invention are schematically described below. The illuminating device according to the embodiment includes at least a light source, a light guide plate which has one side surface placed adjacent to the light source and outputs light incident from the side surface from a front surface (light outputting surface) of the light guide plate, an optical sheet (hereinafter, also referred to as prism sheet) including prism arrays each having at least two inclined surfaces and ridge line extending in one direction (direction along the side surface of the light guide plate from which light is incident), and a reflector disposed on a rear surface (surface opposite to the light outputting surface) of the light guide plate.

The main configurations of the illuminating device according to the embodiment are as follows.

(Configuration 1) A light guide plate is used, in which an output angle of light, which is output from the light outputting surface of the light guide plate, is in a range between 60 and 80 degrees with respect to a direction of a vertical line of the light outputting surface of the light guide plate when the luminance or the luminous intensity of the light reaches a peak (or the maximum value).

(Configuration 2) On the front surface of the light guide plate, a part of light incident at an incident angle smaller than a critical angle on the front surface is reflected. The reflected light contains a higher ratio of s-polarized light components, and obliquely travels through the light guide plate toward the rear surface. The light is further reflected on the rear surface and by the reflector, and obliquely travels again through the light guide plate to reach the front surface. The light guide plate has a birefringence. When the reflected light obliquely travels between the front surface and the rear surface of the light guide plate to propagate therethrough, polarized light components are converted so as to contain more p-polarized light components than s-polarized light components. Specifically, the light guide plate is provided with a birefringence so that s-polarized light components may be converted into p-polarized light components with efficiency of 90% or more.

(Configuration 3) The reflector is formed on the rear surface of the light guide plate. Specifically, a reflective surface of the reflector is directly formed on the rear surface of the light guide plate, or installed via a transparent medium (transparent member having a refractive index higher than that of air and lower than that of the light guide plate, or space formed by an air layer). In the case of installment via a space, the reflector is disposed by providing a space of less than 30 nm from the rear surface, or a space of 50 nm to 240 nm from the rear surface of the light guide plate.

(Configuration 4) The optical sheet (prism sheet) includes prism arrays on a surface on the light guide plate side or on a surface opposite thereto in order to refract the light in a front direction (the direction of the vertical line of the light outputting surface of the light guide plate) when the light from the light guide plate is made incident on the optical sheet at an output angle at which the luminance or the luminous intensity of light reaches a peak. Further, the prism sheet is made of a transparent medium which does not produce a phase difference when the light that has an output angle at which the luminance or the luminous intensity of the light output from the light guide plate reaches a peak passes through the prism sheet.

(Configuration 5) The light guide plate includes a thin plate-shaped transparent medium for guiding light output from the light source. On the front surface of the light guide plate, a high refractive index layer having a refractive index higher than that of the thin plate-shaped transparent medium is further formed. In this case, a thickness dh of the high refractive index layer may satisfy the following expression (3) (m is an integer), where nh denotes a refractive index of the high refractive index layer, and γ denotes an angle (inclination angle from a direction vertical to the light outputting surface of the light guide plate) when light output at an output angle at which a luminance or luminous intensity becomes maximum travels through the high refractive index layer.

[Expression 3]

dh=λ/(4·nh·cos γ)(2m+1) (3)

With the above-mentioned configuration, the illuminating device of the embodiment operates as follows.

With Configuration 1, light output from the light guide plate may be obtained as output light containing more p-polarized light components because of a difference in transmittance between p-polarized light components and s-polarized light components at an interface between the light guide plate and air. For example, in the case of a light guide plate having a peak angle of a luminance (light output angle at which a luminance reaches a peak) set to 75 to 80 degrees, output light containing more p-polarized light components may be obtained at the peak angle of the luminance.

In this case, reflection of the s-polarized light components is large at the interface between the light guide plate and air. Thus, of light incident on the front surface of the light guide plate at an incident angle corresponding to the peak angle of the luminance, light reflected to travel through the light guide plate contains more s-polarized light components. On the other hand, in Configuration 2, of light propagating from the front surface to the rear surface of the light guide plate to return to the front surface again, s-polarized light components are converted into p-polarized light components with high efficiency.

Configuration 3 is for reflecting light in the rear surface of the light guide plate toward the front surface of the light guide plate.

With Configuration 4, when light, which has an angle at which the luminance or the luminous intensity of the light output from the light guide plate reaches a peak, is made incident on the prism sheet and output in the front direction, the light may be advanced within the prism sheet while maintaining the polarization state of the light with a minimum of changes. Therefore, the p-polarized light passing through the prism sheet may maintain the state of the p-polarized light. In particular, when the prism arrays are provided on a surface opposite to the light guide plate, the light incident on the prism sheet is refracted at two points, that is, the surface on the light guide plate side and the surface opposite thereto of the prism sheet, at the interface between the prism sheet and air. At the time of the refraction, since the transmittance of the p-polarized light components becomes higher than that of the s-polarized light components, the light output from the prism sheet contains relatively more p-polarized light components as compared to the light incident on the prism sheet.

Configuration 5 is for increasing transmittance of p-polarized light components when light output from the light guide plate at an angle at which a luminance or luminous intensity reaches a peak passes through the interface between the light guide plate and air, and increasing reflectance of s-polarized light components. Thus, the light output from the light guide plate at the angle at which the luminance or the luminous intensity reaches the peak contains more p-polarized light components. The s-polarized light components reflected at the interface between the light guide plate and air are efficiently converted into p-polarized light components within the light guide plate, to thereby realize a light guide plate which outputs light containing more p-polarized light components. Based on Configurations 1 to 3, the illuminating device including some or all of Configurations 4 and 5 may be employed, to thereby obtain illuminating light containing a large light intensity of predetermined linearly polarized light components (p-polarized light components).

The main configuration of the illuminating device of the embodiment of the present invention has schematically been described above. Hereinafter, the embodiment of the present invention is further described with reference to the attached drawings. However, the present invention is not limited to what is described with reference to the embodiment above and below and may include various modifications. Some of the examples described below may be used in combination.

[Illuminating Device]

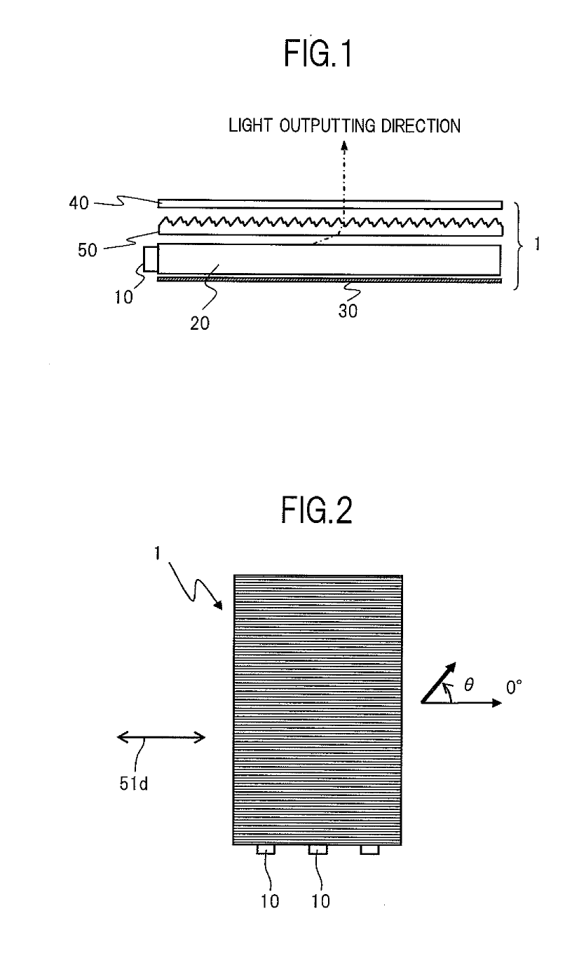

FIG. 1 is a cross sectional view illustrating a main configuration of an illuminating device 1 according to an embodiment of the present invention. FIG. 2 is a plan view schematically illustrating the configuration of the illuminating device 1. In FIG. 2, a definition of an azimuth angle θ described below is also illustrated. The illuminating device 1 according to this embodiment is formed into a thinner shape, and is capable of emitting illuminating light containing a high ratio of predetermined polarized light components. Thus, the illuminating device 1 is suitable in use for a backlight of a liquid crystal display device. The backlight irradiates a display area of a liquid crystal display panel (not shown) with light from therebehind and illuminates the display area in just proportion, and hence it is desired that a light outputting surface of the backlight be formed into about the same shape as the display area. It should be noted that, in FIG. 2, a ridge line direction 51d in a prism sheet described below is also illustrated.

The illuminating device 1 includes a light guide plate 20, light sources 10 that are arranged in adjacent to one side surface of the light guide plate 20, a reflection sheet 30 which is disposed on a rear surface of the light guide plate 20 and functions as light reflective means, and a prism sheet 50 which is disposed on a front surface of the light guide plate 20 so as to cover substantially the entire front surface of the light guide plate 20 and functions as light control means. If required, a diffusion sheet 40, which has a function to diffuse light passing through the diffusion sheet 40, may be disposed on a front surface of the prism sheet 50, as in the illuminating device 1 illustrated in FIG. 1. In FIG. 1, an example of a light path of light, which is output from the light guide plate 20, is illustrated with an alternate long and short dash line. In this specification, a direction in which light is output from the illuminating device 1 (upward direction on the sheet of FIG. 1 or as side on which the liquid crystal panel is disposed) is defined as the front surface, and an opposite direction (downward direction on the sheet of FIG. 1 or an opposite side to the side on which the liquid crystal panel is disposed) is defined as the rear surface. In order to actually manufacture the illuminating device, a mechanical structure such as a frame, and an electric structure such as a power source and an electrical structure such as wiring, which is necessary for allowing the light sources to emit light, are required. However, typical means may be employed as those elements, and hence detailed descriptions thereof are omitted in this specification.

Preferably, each light source 10 satisfies conditions of a small size, a high luminous efficiency, and low heating. For example, the light source 10 which satisfies the above-mentioned conditions suitably includes a fluorescent lamp and a light emitting diode (LED). In the following description, the LED is utilized as the light source 10, but the present invention is not limited thereto. When the LED is utilized as the light source 10, the required numbers of the LEDs are disposed side by side on the side surface of the light guide plate 20 (three LEDs are illustrated in FIG. 2, but the present invention is not limited thereto) because the LEDs are formed as point-like light sources. Alternatively, an optical element, which converts light from the LEDs into linear light, may be disposed between the LEDs and the light guide plate 20. In any case, the light sources 10 are disposed on the one side surface of the light guide plate 20.

The LED emitting white color light may be used as the light source 10. An example of such LED includes an LED in which a blue color light-emitting element is combined with a phosphor which emits yellow color light by being exited with the blue color light, to thereby realize a white color illumination. Alternatively, there may be utilized an LED which may realize the white illumination having luminescence peaks in blue, green, and red colors by combining a blue color light-emitting element or an ultraviolet light-emitting element with a phosphor which is illuminated by being excited with the light emitted from the blue color light-emitting element or the ultraviolet light-emitting element.

When a display device including the illuminating device 1 realizes a full-color display by additive color mixing, it is preferable to use, as the light sources 10, LEDs which emit three primary colors of red, blue, and green. For example, when a full-color liquid crystal display panel is used to be irradiated with the illuminating light, a display device with a wider color reproduction range may be realized by using the light sources which have a luminescence peak wavelength corresponding to a transmission spectrum of a color filter of the liquid crystal display panel. Alternatively, when the full-color display is realized by a color field sequential, the color filter which is a cause of an optical loss is not essential for the liquid crystal display panel, and hence a display device with less optical loss and a wider color reproduction range may be realized by using the LEDs which emit the three primary colors of red, blue, and green.

The light sources 10 are connected to a power source and control means which controls ON/OFF of the light sources 10 (either not shown) through wiring.

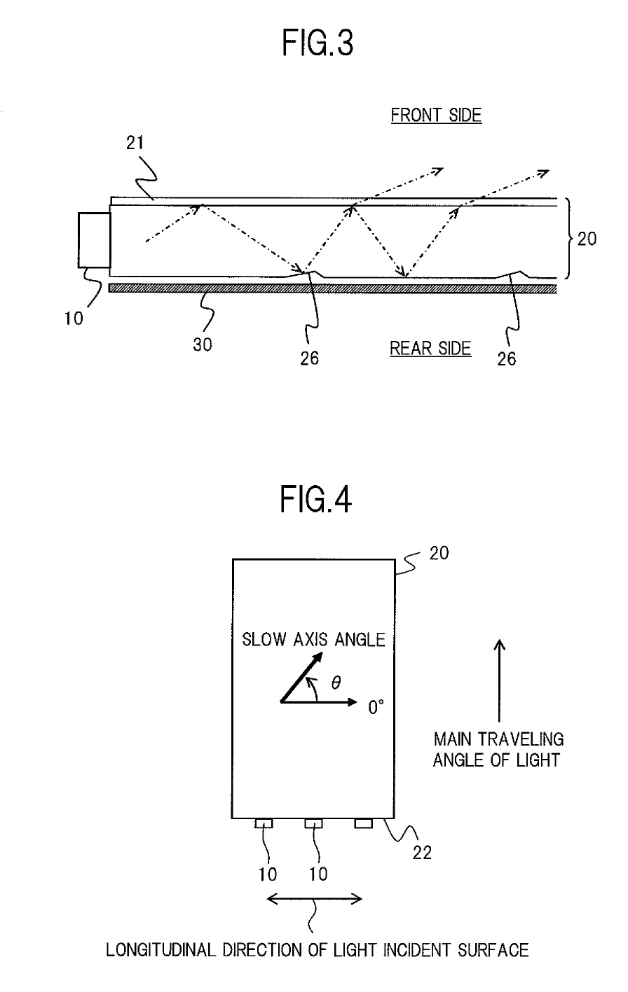

FIG. 3 is a schematic cross sectional view illustrating a part of a sectional structure of the illuminating device 1 according to the embodiment. The light guide plate 20 has a function of outputting light in a planar shape by guiding light output from the light source 10 to be made incident from a side surface (end surface) of the light guide plate 20, and outputting a part of the light to the front surface. Thus, the light guide plate 20 includes a plate-shaped member which takes a substantially rectangular shape and is transparent with respect to visible light, and has a structure for outputting light incident from the side surface to be propagating through the light guide plate 20 to the front surface. The light incident from the side surface of the light guide plate 20 by the light source 10 is guided (propagating) through the light guide plate 20.

A configuration for outputting the light, which propagates within the light guide plate 20 by being repeatedly reflected, from the front surface of the light guide plate 20 may be realized by a configuration in which a traveling angle of the light, which is propagating within the light guide plate, is changed by providing, on the rear surface of the light guide plate 20, minute steps, a convexo-concave shape, a lens shape, dot printing by using a white pigment, or the like. In consideration of a manufacturing cost of the light guide plate 20 or efficiency of the light which is output from the light guide plate 20, it is desired to form minute shapes on the rear surface or the front surface of the light guide plate 20 in order to change the traveling angle of the light propagating within the light guide plate 20. The minute shapes in this embodiment may be realized by such shapes as steps, a convexo-concave shape, or a lens shape, which include at least an inclined surface capable of changing the traveling angle of light propagating within the light guide plate 20. This embodiment employs an inclined surface portion 26, as the configuration for outputting light propagating within the light guide plate 20 to the front surface of the light guide plate 20. The inclined portion 26 has a minute inclined surface capable of changing a traveling angle of light, and is formed on the rear surface of the light guide plate 20.

It is important that the light guide plate 20 be formed of a material which is transparent to visible light and has a birefringence. Examples of the material for the light guide plate 20 include a polycarbonate resin and a cyclic olefin resin. For example, the light guide plate 20 having a birefringence may be realized by using a uniaxially extending transparent resin as a base material and transferring, to the front surface or the rear surface, a minute structure for outputting light propagating through the light guide plate to the front surface. Alternatively, in the case of forming the light guide plate 20 by injection molding, a birefringence may be provided by utilizing internal residual stress produced in a flow direction of the resin. A birefringence may be provided by sticking a phase difference film to the front surface or the rear surface of the optically isotropic light guide plate 20 made of an acrylic resin or the like. In this case, the light obliquely travels through the phase difference film to be reciprocated. Hence, as in the case of the birefringence provided to the thin plate-shaped transparent medium constituting the light guide plate 20 in the embodiment, a birefringence may be provided to the phase difference film so that light output from the light guide plate 20 at a peak angle can contain more p-polarized light components than s-polarized light components.

The birefringence of the light guide plate 20 needs to be a uniaxial anisotropy having a refractive index anisotropy in a plane, and conditions of the birefringence may be defined by a phase difference (generally, a product Δnd of refractive index anisotropy Δn and its thickness d) and a slow axis angle. Concerning specific conditions for the birefringence of the light guide plate 20, optimal conditions vary depending on a relationship with other components, and hence are detailed below in description of a specific configuration. The present invention does not exclude a biaxial anisotropy as the birefringence of the light guide plate 20.

As illustrated in FIG. 2, when the illuminating device 1 is seen from a plane, an azimuth angle θ in the embodiment is defined as an angle in an anticlockwise direction with a longitudinal direction of the side surface (a light incident surface) having the light source 10 disposed therein set to 0 degrees. A slow axis angle of the light guide plate 20 is defined by an azimuth angle θ as illustrated in FIG. 4. In other words, an azimuth angle of light output from the light source 10 to be incident on the light guide plate 20 and propagating through the light guide plate 20 in a main traveling angle is 90 degrees.

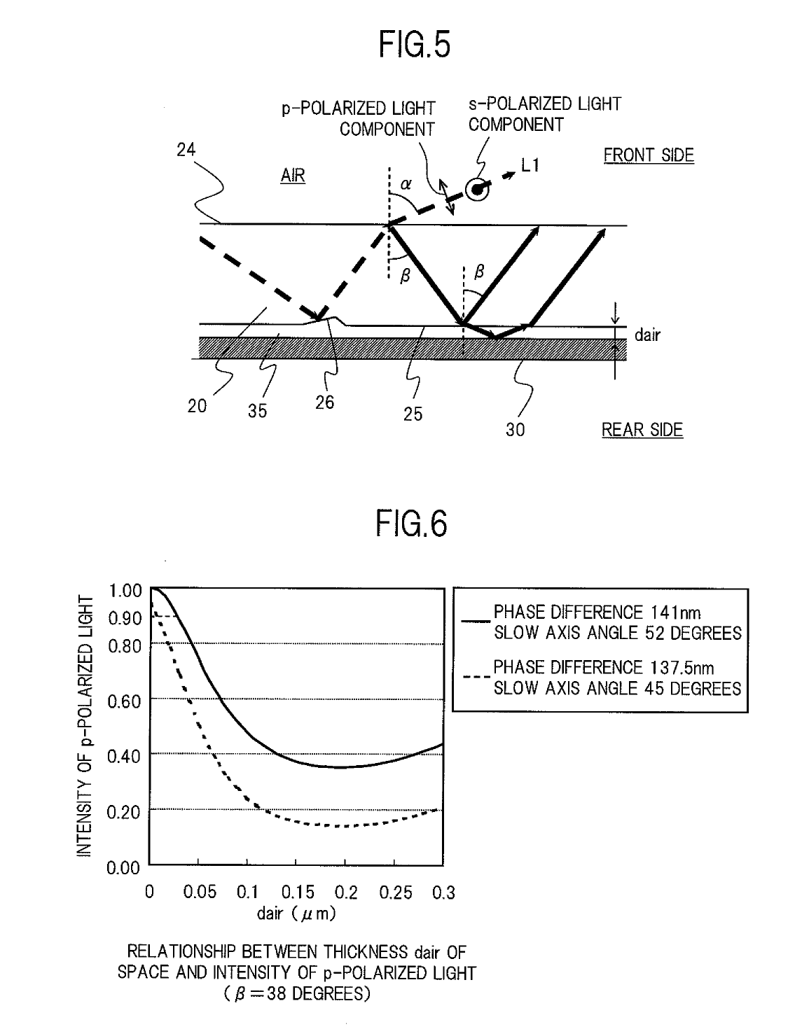

FIG. 5 is a partial cross sectional view illustrating the light guide plate 20 and the reflector 30. The light source 10 (not shown) is disposed on the left side of FIG. 5. In FIG. 5, a polar angle (output angle) α of light output from the front surface of the light guide plate 20 is defined as inclination from a vertical line (normal line) direction with the vertical line direction of the light outputting surface (front surface) of the light guide plate 20 set to 0 degrees. Similarly, a polar angle (traveling angle) β of light traveling through the light guide plate is defined as inclination from the vertical line (normal line) direction with the vertical line direction of the light outputting surface (front surface) of the light guide plate 20 set to 0 degrees.

In the illuminating device 1 according to this embodiment, when the light from the light sources 10 is incident on the light guide plate 20 from one side surface of the light guide plate 20, the light guide plate 20 is used, in which an index value regarding the intensity of light output from the front surface of the light guide plate 20 (for example, luminance or luminous intensity) becomes the maximum value in a direction that the azimuth angle θ is almost 90 degrees and the output angle α is in a range between 65 and 80 degrees. The above-mentioned light guide plate 20 may be realized by forming on the rear surface of the light guide plate 20 a plurality of inclined surface portions 26 each having an inclined surface to have an inclination angle of within a range between 0.5 and 3 degrees with respect to the light outputting surface of the light guide plate 20. A portion which becomes a local step by the inclined surface portion 26 is formed on the rear surface so that an interval/pitch between the inclined surface portion 26 and another inclined surface portion 26 may be several tens of micrometers (μm) to hundreds of tens of micrometers (μm).

When an output angle of the light output from the light guide plate 20, with which the luminance or luminous intensity reaches a peak (maximum value) is inclined with respect to the direction of the vertical line (normal line) of the light outputting surface of the light guide plate 20, the light output at the output angle contains more p-polarized light components. As illustrated in FIG. 5, of light L1 output at the output angle α, a linearly polarized light component in which a polarization direction of an electric vector of the light is contained in a plane including the vertical line (normal line) of the light outputting surface of the light guide plate 20 and a traveling angle of light L1 which is output from the light guide plate 20 at an output angle α is defined as p-polarized light component, and a linearly polarized light component in which the p-polarized light component is orthogonal to the polarization direction of the electric vector is defined as s-polarized light component, respectively, and the s-polarized light component is vertical to the sheet of FIG. 5. As described above, the luminance or the luminous intensity of the light L1 which is output from the light guide plate 20 becomes the maximum value when the azimuth angle θ in the traveling angle of the light L1 is 90 degrees. Therefore, light traveling in this direction is aimed at in the following description. Unless otherwise stated, the linearly polarized light in which the polarization direction of the electric vector of the light is contained within a plane which includes the vertical line (normal line) of the light outputting surface of the light guide plate 20 and a direction of the azimuth angle θ of 90 degrees is referred to as p-polarized light, and the linearly polarized light in which the p-polarized light is orthogonal to the polarization direction of the electric vector is referred to as the s-polarized light. As described above, the light which is output in a direction inclined with respect to the direction of the vertical line of the light outputting surface of the light guide plate 20, it is well known that the p-polarized light components become larger in ratio than the s-polarized light components because there is a difference in transmittance between the p-polarized light and the s-polarized light when the light is refracted at the interface between the light guide plate 20 and an air layer (symbolized by AIR in FIG. 5).

In the embodiment, as the light guide plate 20, an example of a light guide plate 20 is described, in which a polycarbonate having an average refractive index of 1.5705 is used, and at an azimuth angle θ=90 degrees, an output angle α where a luminance of light L1 becomes the maximum value is 76 degrees, and an output angle α where luminous intensity becomes the maximum value is 68 degrees. However, the present invention is not limited to this example. For example, for the light guide plate 20, a transparent medium having a refractive index of about 1.46 to 1.6 may be used. In the case of the light guide plate 20 of the embodiment, for light of an output angle α=76 degrees, when the light passes through the interface between the light guide plate 20 and air (AIR), a degree of polarization ρp of p-polarized light of output light becomes about 23% because of a difference in transmittance between the p-polarized light and s-polarized light. More specifically, 88% of the p-polarized light is transmitted while only 45% of the s-polarized light is transmitted. Hence, light reflected on the interface between the light guide plate 20 and air to be left in the light guide plate 20 contains s-polarized light components by about 4.6 times more than p-polarized light components.

As illustrated in FIG. 3, it is desirable that the light guide plate 20 includes a thin plate-shaped transparent medium and a member higher in refractive index than the transparent medium. On the front surface of the light guide plate 20, a high refractive index member (hereinafter, referred to as high refractive index layer 21) is formed into a layer shape. The inclusion of the high refractive index layer 21 enables an increase of p-polarized light components of light output from the light guide plate 20. The high refractive index layer 21 may be formed so that its thickness dh can satisfy the following condition with respect to an angle at which a luminance or luminous intensity of the light output from the light guide plate 20 becomes the maximum value. In other words, a thickness dh satisfies the above-mentioned expression (3), where nh denotes a refractive index of the high refractive index layer 21 and γ denotes a traveling angle (angle of inclination from a direction vertical to the light outputting surface of the light guide plate 20) of light output from the light guide plate 20, light output at an angle at which a luminance or luminous intensity becomes the maximum value through the high refractive index layer 21. In the expression (3), λ denotes a wavelength of light, and m is an integer of 0 or more. The wavelength λ is a wavelength of visible light. For example, a value of 550 nm where visibility is high may be used. The thickness dh of the high refractive index layer 21 may be a value obtained by setting a value of m to an integer of 1 or more. However, when the thickness dh is lager, the influence of wavelength dependence of the refractive index of the transparent medium constituting the high refractive index layer 21 is larger, and hence it is desirable to select a thickness dh calculated with m=0.

TABLE 1

| High | | | | |
|---|---|---|---|---|
| refractive | Refractive | Thickness | p | s |
| index layer | index | (nm) | Transmittance | Reflectance |
| (None) | — | — | 88% | 45% |
| Ultraviolet | 1.65 | 103 | 89% | 51% |
| curable | | | | |
| resin | | | | |
| Ultraviolet | 1.70 | 99 | 90% | 54% |
| curable | | | | |
| resin | | | | |
| SiN | 1.85 | 87 | 93% | 62% |
| Ta₂O₅ | 2.00 | 79 | 95% | 68% |
| TiO₂, ZnS | 2.35 | 65 | 99% | 77% |

Table 1 illustrates a relationship between a material of the high refractive index layer 21 and its refractive index and an optimal thickness with respect to light of an output angle α=76 degrees. In Table 1, in each condition, when a refractive index of the light guide plate is 1.5705, transmittance of p-polarized light (p transmittance in Table 1) and reflectance of s-polarized light (s reflectance in Table 1) at the interface between the light guide plate and air are described. Hereinafter, unless otherwise specified, an (average) refractive index of the light guide plate is 1.5705.

As illustrated in Table 1, when the high refractive index layer 21 is formed, transmittance of the p-polarized light components is increased, while reflectance of the s-polarized light components is increased. Hence, the light output from the light guide plate 20 contains more p-polarized light components. When a refractive index of the high refractive index layer 21 is higher, its effect is larger. The high refractive index layer 21 may be implemented by an ultraviolet curable resin at relatively low cost. However, it is difficult to set the refractive index higher than other materials. On the other hand, materials such as SiN, Ta₂O₅, TiO₂, and ZnS can set high refractive indexes, providing larger effects, but the costs are high. Thus, in actual application, conditions suitable to a product may be selected based on a balance between costs and effects.

Even when the high refractive index layer 21 is formed as illustrated in FIG. 3, if the light guide plate 20 has no appropriate birefringence, an amount of p-polarized light components of light actually output from the light guide plate 20 is smaller than an expected value, due to a difference in reflection between p-polarized light and s-polarized light at the interface between the light guide plate 20 and air. This may be attributed to the fact that light reflected on the interface between the light guide plate 21 and air to be left in the light guide plate 20 contains more s-polarized light components than p-polarized light components, and hence the light propagating through the light guide plate 20 contains more s-polarized light components. For example, when a layer having a refractive index of 2.0 is formed as the high refractive index layer 21, 95% of p-polarized light is transmitted while only 32% of s-polarized light is transmitted. As a result, the light reflected on the interface between the light guide plate 20 and air to be left in the light guide plate 20 contains s-polarized light components by 13.6 times more than p-polarized light components. Thus, to increase an amount of p-polarized light components of light output from the light guide plate 20, it may be extremely effective to efficiently convert s-polarized light left in the light guide plate 20 into p-polarized light.

The reflector 30 is disposed on the rear surface of the light guide plate 20. The reflector 30 has a function of reflecting light output to the rear surface of the light guide plate 20 to return to the light guide plate 20, and is used for effectively utilizing the light output to the rear surface of the light guide plate 20. For the reflector 30, a reflective member having its reflective surface of high reflectance formed on a support base material such as a resin plate or a polymer film may be used. The reflective surface of the reflective member may be formed by forming a metal thin film of high reflectance such as aluminum or silver on the support base material by an evaporation method or a sputtering method, forming a dielectric multilayer which serves as an increase reflective film on the support base material, or coating the support base material with a light reflective paint. The reflective surface may be formed by laminating a plurality of transparent media of different refractive indexes to function as the reflector 30.

In particular, a birefringence is imparted to the light guide plate 20, and hence s-polarized light left in the light guide plate 20 is efficiently converted into p-polarized light. In order to efficiently convert s-polarized light left in the light guide plate 20 into p-polarized light, as illustrated in FIG. 5, the inventors studied, by simulation, on how much s-polarized light was converted into p-polarized light when the s-polarized light traveling from the front surface 24 to the rear surface 25 of the light guide plate 20 was reflected on the rear surface 25 and by the reflector 30 to return to the front surface 24 (along the light path indicated by the solid line of FIG. 5). Specifically, the inventors made judgment based on intensity of p-polarized light when light started from the front surface 24 of the light guide plate 20 in a state of intensity of p-polarized light of 0 (in other words, s-polarized light intensity is 1) was reflected on the rear surface 25 and by the reflector 30 to return to the front surface 24. In other words, in this judgment, when intensity of p-polarized light is 1, it means that s-polarized light has completely been converted into p-polarized light.

Hereinafter, embodiments of the light guide plate 20 and the reflector 30 disposed on its rear surface examined by the inventors and corresponding conditions of a birefringence of the light guide plate 20 are further described.

### Embodiment 1 of Light Guide Plate and Reflector Disposed on its Rear Surface

FIG. 6 is a graph illustrating a relationship between a space d air (refer to FIG. 5) between the light guide plate 20 and the reflector 30 and intensity of p-polarized light in the case of a traveling angle β=38 degrees of light propagating through the light guide plate 20. The light propagating at the angle β=38 degrees is light output from the light guide plate 20 at an output angle α of about 76 degrees and propagating at a peak angle of a luminance. In this embodiment, an output angle close to a peak angle of a luminance or luminous intensity approximately falls within a range of from 35 to 39 degrees of incident angles β of light incident from the inside of the light guide plate 20 on the front surface 24. This range of from angles 35 to 39 degrees should be taken into consideration. The graph of FIG. 6 illustrates a case where, for light with a wavelength of 550 nm, birefringence conditions of the light guide plate 20 are a phase difference of 141 nm and a slow axis angle of 52 degrees, including a case of a phase difference 137.5 nm and a slow axis angle 45 degrees.

The conditions of the birefringence of the light guide plate 20, that is, the phase difference of 141 nm and the slow axis angle of 52 degrees, are conditions under which s-polarized light propagating from the front surface 24 of the light guide plate 20 to the rear surface 25 becomes substantially circular polarized light on the rear surface 25, with respect to light propagating at the angle range of from β=35 to 39 degrees, which should be taken into consideration, among the traveling angles β of light propagating through the light guide plate 20s. The substantially circular polarized light then travels from the rear surface 25 at a traveling angle β to return to the front surface 24, to thereby be converted into p-polarized light.

As illustrated in FIG. 6, intensity of p-polarized light is higher as the space d air is closer to 0, increasing conversion efficiency of s-polarized light into p-polarized light. Thus, it is desirable to set the space d air between the rear surface 25 of the light guide plate 20 and the reflector 30 to 0.

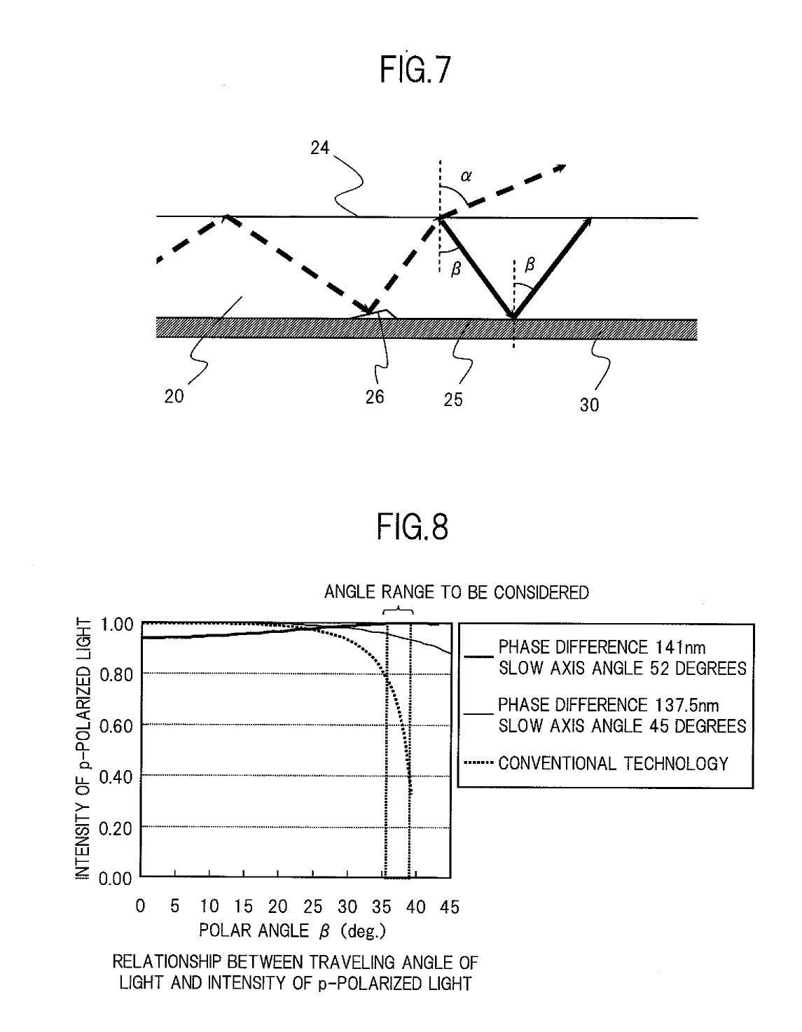

FIG. 7 is a partial cross sectional view illustrating the light guide plate 20 and the reflector 30 of the illuminating device according to the embodiment of the present invention. As illustrated in FIG. 7, this embodiment employs a structure where the light guide plate 20 and the reflector 30 are contacted together without providing any space between the rear surface 25 of the light guide plate 20 and the reflector 30 (Embodiment 1). Hence, a minute inclined surface portion 26 is formed on the rear surface of the light guide plate 20 to change a traveling angle of light in a structure of being concaved inside the light guide plate 20.

This structure may be realized by directly forming the reflector 30 on the rear surface 25 of the light guide plate 20 or fixing the reflector 30 to the rear surface 25 of the light guide plate 20 via a transparent adhesive material (not shown in FIG. 7) having a refractive index equal to that of the light guide plate 20. For the reflector 30, a reflective member which exhibits specular reflection is used.

Specifically, in the case of directly forming the reflector 30 on the rear surface 25 of the light guide plate 20, the reflector 30 may be realized by forming a metal thin film such as aluminum or silver having high reflectance on the rear surface of the light guide plate 20 by an evaporation method or a sputtering method. Alternatively, the reflectance means 30 may be formed by a method of forming a dielectric multilayer which is to serve as an increase reflective film or a method of applying a light reflective paint.

As the reflector 30 in the case of fixing the reflector 30 to the rear surface 25 of the light guide plate 20, specifically, reflector prepared by forming a surface having high reflectance and exhibiting specular reflection on a support base material such as a resin plate or a polymer film may be used. The reflective surface may be formed by forming a metal thin film such as aluminum or silver having high reflectance on the support base material by an evaporation method or a sputtering method, forming a dielectric multilayer on the support base material to serve as an increase reflective film, or a method of coating the support base material with a light reflective paint. The reflective surface may function as reflector by stacking a plurality of transparent media of different refractive indexes. In order to realize a state where substantially no space is provided between the reflector 30 and the rear surface 25 of the light guide plate 20, a material functioning as a transparent adhesive material having a refractive index equal to that of the light guide plate 20 may be supplied between the rear surface 25 of the light guide plate 20 and the reflector 30.

FIG. 8 is a graph illustrating a relationship between a traveling angle β of light (wavelength 550 nm) propagating through the light guide plate 20 and intensity of p-polarized light. In the graph of FIG. 8, data indicated by the thick line and the thin line correspond to p-polarized light intensities obtained under conditions of a birefringence of the light guide plate 20, that is, when a phase difference is 141 nm and a slow axis angle is 52 degrees (thick line) and when a phase difference is 137.5 nm and a slow axis angle is 45 degrees (thin line). Both cases employ the structure of FIG. 7 where no space is provided between the light guide plate 20 and the reflector 30. The graph of FIG. 8 includes a case of a conventional technology (dotted line).

As illustrated in FIG. 8, when the space d air of 0 is set between the rear surface 25 of the light guide plate 20 and the reflector 30 and the conditions of the birefringence of the light guide plate 20 is set to a phase difference of 141 nm and a slow axis angle of 52 degrees, intensity of p-polarized light becomes approximately 1.0 within the angle range of from 35 to 39 degrees to be taken into consideration concerning traveling angles β of light propagating through the light guide plate 20, enabling conversion of s-polarized light into p-polarized light with extremely high efficiency. Thus, the light output from the light guide plate 20 contains more p-polarized light components, realizing an illuminating device capable of outputting light which contains many desired linearly polarized light components.

When intensity of p-polarized light is 0.9 or more, practically useful effects may be obtained, and hence the present invention does not exclude this range. Thus, as long as the space d air is 0 between the rear surface 25 of the light guide plate 20 and the reflector 30, even if the conditions of the birefringence of the light guide plate 20 are a phase difference of 137.5 nm and a slow axis angle of 45 degrees, intensity of p-polarized light may be set to 0.9 or more within the angle range (35 to 39 degrees) among traveling angles β of light propagating through the light guide plate.

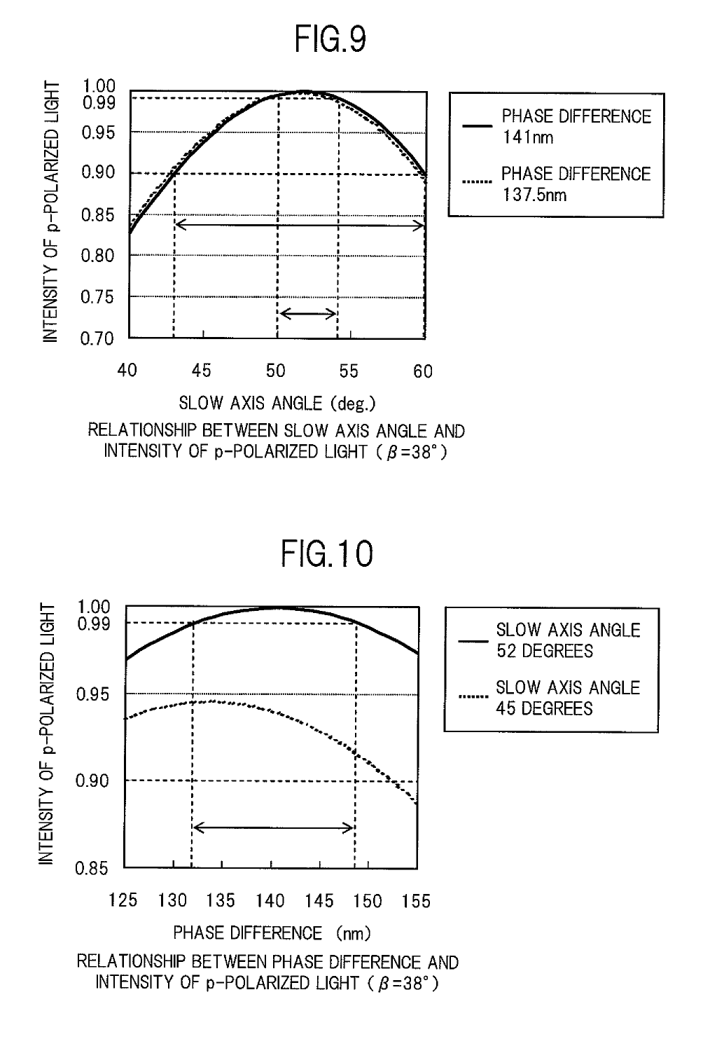

FIG. 9 is a graph illustrating a relationship between a slow axis angle θ of the light guide plate 20 and intensity of p-polarized light when a space d air of 0 is set between the light guide plate 20 and the reflector 30 and a phase difference of the light guide plate 20 is 141 nm in light with a wavelength of 550 nm, including a case where a phase difference of the light guide plate 20 is 137.5 nm.

In this case, an optimal condition of a slow axis angle of the light guide plate 20 is about 52 degrees. Effects substantially similar to those of the optimal condition are obtained when an intensity of p-polarized light is 0.99 or more, and hence a desirable range of slow axis angles is from 50 to 54 degrees when the space d air between the light guide plate 20 and the reflector 30 is 0. Practically useful effects may be obtained when intensity of p-polarized light is 0.9 or more, and hence the slow axis angle of the light guide plate 20 falls within a range of from 43 to 60 degrees when the space d air of 0 is set between the light guide plate 20 and the reflector 30. In the embodiment, attention is focused on light which reaches a peak luminance or peak luminous intensity and which is output within an angle range of from about 64 to 80 degrees at an azimuth angle θ=90 degrees which is a light guide direction. For an orientation of a slow axis, an orientation of 38 degrees clockwise or anticlockwise (52 or 128 degrees in the case of the slow axis angle defined in FIG. 4) with respect to an azimuth angle (main traveling angle of light) of the ray which reaches the peak luminance or peak luminous intensity is an optimal condition. A range of from 36 to 40 degrees is a desirable range for an orientation, and a range of from 30 to 47 degrees is a range for obtaining practically useful effects.

FIG. 10 is a graph illustrating, for light with a wavelength of 550 nm, a relationship between a phase difference of the light guide plate 20 and intensity of p-polarized light when a space d air between the light guide plate 20 and the reflector 30 is 0 and a slow axis angle of the light guide plate 20 is 52 degrees, including the case where the slow axis angle of the light guide plate 20 is 45 degrees.

In this case, an optimal condition of a phase difference of the light guide plate 20 is about 141 nm. This value is obtained as quarter wavelength×1.025 with respect to the wavelength 550 nm having a high relative luminous efficiency in photopic vision. In this judgment, the wavelength 550 nm is focused on. Effects substantially similar to those of the optimal condition are obtained when an intensity of p-polarized light is 0.99 or more, and hence a desirable range of phase differences when the space d air of 0 is set between the light guide plate 20 and the reflector 30 is a range of from about 132 nm to about 149 nm. This range is a range of from quarter wavelength×0.96 to quarter wavelength×1.08 with respect to the wavelength 550 nm focused on in this judgment. Practically useful effects are obtained when intensity of p-polarized light is 0.9 or more. Thus, a range of phase differences of the light guide plate 20 when the space d air is 0 is a range of from quarter wavelength×0.9 to quarter wavelength×1.2 (range of from about 124 nm to about 165 nm).

In FIG. 10, when the slow axis angle of the light guide plate 20 is 45 degrees, intensity of p-polarized light cannot exceed 0.95 at any phase difference, and hence highest polarized light conversion efficiency cannot be realized. However, when the space between the rear surface 25 of the light guide plate 20 and the reflector 30 is set to 0, intensity of p-polarized light of 0.9 or more which provides practically useful effects may be achieved.

Even when there is a space between the rear surface 25 of the light guide plate 20 and the reflector 30, if the space is smaller than 30 nm, similar effects may be obtained by setting a slow axis angle and a phase difference of the light guide plate 20 as in the case of the structure where the reflector 30 and the light guide plate 20 are contacted together.

### Embodiment 2 of Light Guide Plate and Reflector Disposed on its Rear Surface

In embodiment 1, the space between the rear surface 25 of the light guide plate 20 and the reflector 30 is 0, and the reflector 30 is contacted to the rear surface 25 of the light guide plate 20.

In this case, for light subjected to total internal reflection to propagate through the light guide plate 20, a loss occurs on the rear surface 25 of the light guide plate 20 in accordance with reflectance of the reflector 30. In other words, for light subjected to total internal reflection to be guided, total reflection is in principle reflectance of 100%, and hence no loss occurs due to reflection. However, in reflection by the reflector 30, reflectance is generally less than 100%, and a light loss occurs in reflection.

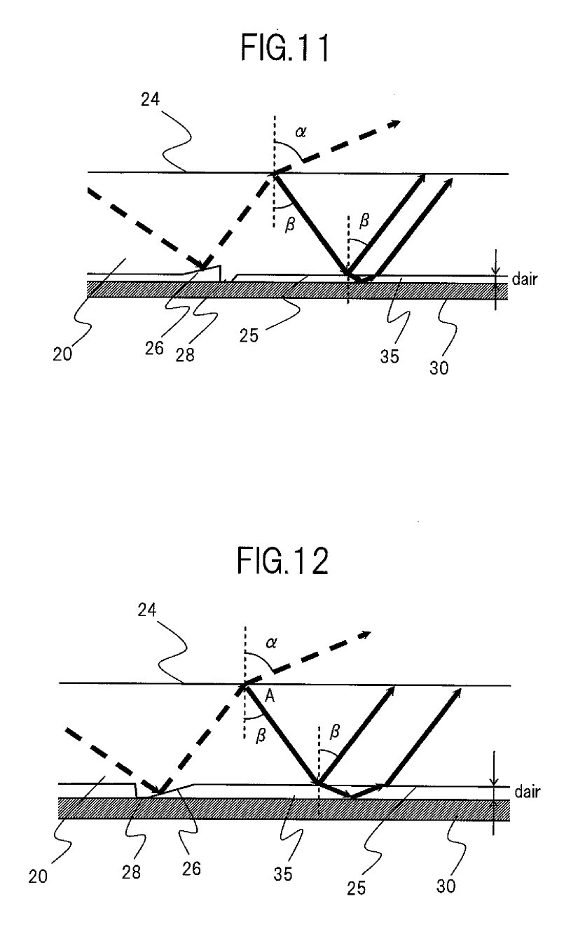

Thus, as illustrated in FIGS. 11 and 12, a space of a given thickness may be produced between the rear surface 25 of the light guide plate 20 and the reflector 30 (Embodiment 2). Each of FIGS. 11 and 12 is a partial cross sectional view illustrating a structure of the light guide plate 20 and the reflector 30 of the illuminating device 1 according to the embodiment of the present invention, where a given space 35 is provided between the rear surface 25 of the light guide plate 20 and the reflector 30.

FIG. 11 illustrates a case where a minute inclined surface portion 26 is formed on the rear surface of the light guide plate 20 to change a traveling angle of light in a structure of being concaved inside the light guide plate 20. When necessary, a protrusion is disposed as a spacer 28 to maintain constant the space 35 between the rear surface 25 of the light guide plate 20 and the reflector 30. The spacer 28 may be formed integrally with the light guide plate 20 on the rear surface 25 of the light guide plate 20. The spacer 28 may desirably be located adjacent to the inclined surface portion 26, and on a side opposite to the light source 10 relative to the inclined surface portion 26. In this case, the spacer 28 may be disposed at a position behind the inclined surface portion 26 for light propagating through the light guide plate 20. As a result, adverse effects of the inclusion of the spacer 28 on optical performance may be suppressed.

The reflector 30 disposed on the rear surface 25 of the light guide plate 20 has high reflectance, and a reflective member having a specular reflective surface formed on the support base material may be used. The reflective surface may be formed by forming a metal thin film of aluminum, silver, or the like having high reflectance on the support base material by an evaporation method or a sputtering method, forming a dielectric multilayer to serve as an increase reflective film, or coating the support base material with a light reflective paint. Alternatively, as a reflective surface, a plurality of transparent media having different refractive indexes may be stacked to function as the reflector 30.

For the support base material, a resin plate, a polymer film, or the like may be used. However, in order to maintain constant the space between the rear surface 25 of the light guide plate 20 and the reflector 30, it is desirable to select a material having a highly flat surface and being resistant to deformation, such as a glass plate or a metal plate, for the support base material.

FIG. 12 is a partial cross sectional view illustrating a structure of the light guide plate 20 and the reflector 30 of the illuminating device according to the embodiment of the present invention.

FIG. 12 illustrates a case where a minute inclined surface portion 26 is formed on the rear surface 25 of the light guide plate 20 to change a traveling angle of light in a structure of being bulged outside the light guide plate 20. When necessary, the spacer 28 is disposed so as to maintain constant the space 35 between the rear surface 25 of the light guide plate 20 and the reflector 30. The spacer 28 may be formed integrally with the light guide plate 20 on the rear surface side of the light guide plate 20. The spacer 28 may desirably be located adjacent to the inclined surface portion 26, and on the same side as the light source 10 relative to the inclined surface portion 26. Thus, in the case of the structure where the minute inclined surface portion 26 on the rear surface of the light guide plate 20 is bulged outside the light guide plate 20, the spacer 28 is formed integrally with the inclined surface portion 26 and protruded in a convex shape from the rear surface 25 to form a flat portion. An inclined surface connected to the rear surface 25 in a direction of a side opposite to a side where the light source 10 is disposed is formed from the flat portion, to thereby form an inclined surface portion 26.

In this case, the spacer 28 may be disposed at a position which is unlikely to get in the way of light incident on the inclined surface of the inclined surface portion 26, of light propagating through the light guide plate 20. As a result, adverse effects of the inclusion of the spacer 28 on optical performance may be suppressed.

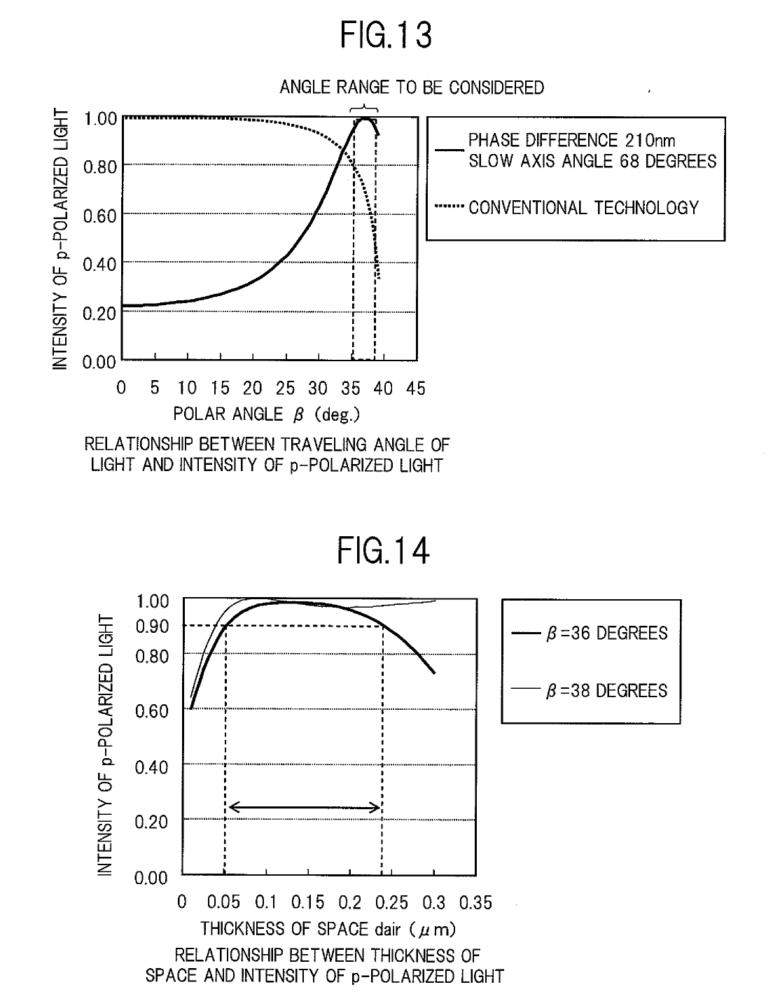

FIG. 13 is a graph illustrating a relationship between a traveling angle β of light (wavelength of 550 nm) propagating through the light guide plate 20 and intensity of p-polarized light in the illuminating device 1 including a given space 35 provided between the rear surface 25 of the light guide plate 20 and the reflector 30, as in the case of the illuminating device illustrated in FIG. 11 or FIG. 12. In the graph of FIG. 13, data indicated by the thick line corresponds to a case where a thickness d air of the space 35 between the rear surface 25 of the light guide plate 20 and the reflector 30 is 140 nm, and conditions of a birefringence of the light guide plate 20 are set such that a phase difference is 210 nm and a slow axis angle is 68 degrees. For comparison, the graph of FIG. 13 includes a case of the conventional technology (dotted line).

As illustrated in FIG. 13, by providing the given space 140 nm between the rear surface 25 of the light guide plate 20 and the reflector 30, and setting the conditions of the birefringence of the light guide plate 20 to the phase difference of 210 nm and the slow axis angle of 68 degrees, intensity of p-polarized light within an angle range to be taken into consideration (incident angle β=35 to 39 degrees) becomes 0.9 or more, enabling conversion of s-polarized light into p-polarized light with high efficiency. Thus, light output from the light guide plate 20 contains more p-polarized light components, realizing an illuminating device for outputting light containing many desired linearly polarized light components.

In other words, even if there is a space provided between the rear surface 25 of the light guide plate 20 and the reflector 30, as long as this space is controlled to be in a given thickness and the birefringence of the light guide plate 20 satisfies appropriate conditions, when among lights propagating through the light guide plate 20, light propagating at an angle to be taken into consideration (incident angle β=35 to 39 degrees) is propagating from the front surface 24 of the light guide plate 20 to the rear surface 25 to return to the front surface 24, s-polarized light components are converted into p-polarized light components with higher efficiency. Thus, light output from the light guide plate 20 contains more p-polarized light components, realizing an illuminating device 1 which outputs light containing many desired linearly polarized light components.

FIG. 14 is a graph illustrating, for light (wavelength of 550 nm) propagating through the light guide plate 20, a relationship between intensity of p-polarized light when s-polarized light propagating from the front surface 24 of the light guide plate 20 to the rear surface 25 returns to the front surface 24 and a thickness d air of a space 35 between the rear surface 25 of the light guide plate 20 and the reflector 30. In this case, conditions of a birefringence of the light guide plate 20 are set such that a phase difference is 210 nm and a slow axis angle is 68 degrees.

Hereinafter, attention is focused on, among traveling angles β of light propagating through the light guide plate 20, a particularly important range of from β=36 to 38 degrees. Light traveling at an angle of β=36 degrees is light where an output angle α from the light guide plate is about 67 degrees, which corresponds to a peak angle of luminous intensity. Light traveling at an angle of β=38 degrees is light where an output angle α from the light guide plate 20 is about 76 degrees, which corresponds to a peak angle of a luminance.

As illustrated in FIG. 14, within the range of from angles β=36 to 38 degrees taken into consideration among the traveling angles of light propagating through the light guide plate 20, in order to satisfy intensity of p-polarized light of 0.9 or more which provides practically useful effects, a thickness d air of the space 35 between the rear surface 25 of the light guide plate 20 and the reflector 30 must be set within a range of from 50 nm (0.05 μm) to 240 nm (0.24 μm).

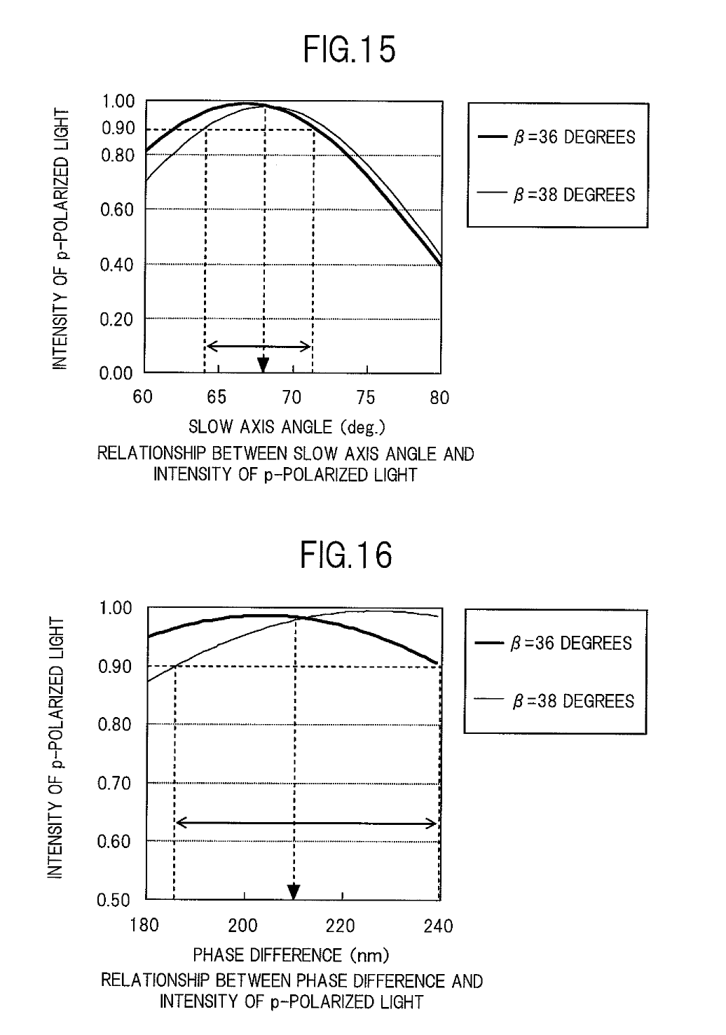

FIG. 15 is a graph illustrating a relationship between a slow axis angle θ of the light guide plate 20 and intensity of p-polarized light under conditions of a thickness d air=140 nm of a space 35 between the rear surface 25 of the light guide plate 20 and the reflector 30 and a phase difference of 210 nm of the light guide plate 20, in each of the cases where angle is β=36 and 38 degrees, respectively of light (wavelength 550 nm) propagating through the light guide plate 20.

In this case, an optimal condition of a slow axis angle θ of the light guide plate 20 is about 68 degrees. Among traveling angles of light propagating through the light guide plate 20, within a range of from angles β=36 to 38 degrees to be taken into particular consideration, a range of slow axis angles θ of the light guide plate 20 which satisfies intensity of p-polarized light of 0.9 or more to provide practically useful effects is a range of from 64 to 71 degrees.

FIG. 16 is a graph illustrating a relationship between a phase difference of the light guide plate 20 and intensity of p-polarized light under conditions of a thickness d air=140 nm of a space 35 between the rear surface 25 of the light guide plate 20 and the reflector 30 and a slow axis angle θ of 68 degrees of the light guide plate 20, in each of the cases where angle β=36 and 38 degrees, respectively, of light (wavelength 550 nm) propagating through the light guide plate 20.

In this case, an optimal condition of a phase difference of the light guide plate 20 is about 210 nm. This value is quarter wavelength×1.53 with respect to the wavelength 550 nm having high relative luminous efficiency in photopic vision. The wavelength 550 nm is focused on in this judgment.

Among traveling angles of light propagating through the light guide plate 20, within a range of from angles β=36 to 38 degrees to be taken into consideration, a range of phase differences of the light guide plate which satisfies intensity of p-polarized light of 0.9 or more to provide practically useful effects is a range of from 186 to 240 nm. This range is a range of from quarter wavelength×1.35 to quarter wavelength×1.75 with respect to the wavelength 550 nm focused on in this judgment.

Thus, when there is a space of a given thickness provided between the rear surface 25 of the light guide plate 20 and the reflector 30, a light guide plate 20 which outputs light having a high degree of polarization of p-polarized light while reducing losses caused by reflection on the rear surface 25 may be realized.

### Embodiment 3 of Light Guide Plate and Reflector Disposed in Its Rear Surface

Embodiments 1 and 2 described above of the light guide plate and the reflector 30 are directed to the case where the space between the rear surface 25 of the light guide plate 20 and the reflector 30 is 0 and the case where the space of the given distance (thickness) is provided. In the case of Embodiment 2, the space of the given distance (thickness) is provided between the rear surface of the light guide plate 20 and the reflector 30, and hence light propagating through the light guide plate 20 can advance by being repeatedly subjected to total internal reflection. Thus, a loss reduction may be expected. However, the distance of the space between the rear surface 25 of the light guide plate 20 and the reflector must be controlled with high accuracy.

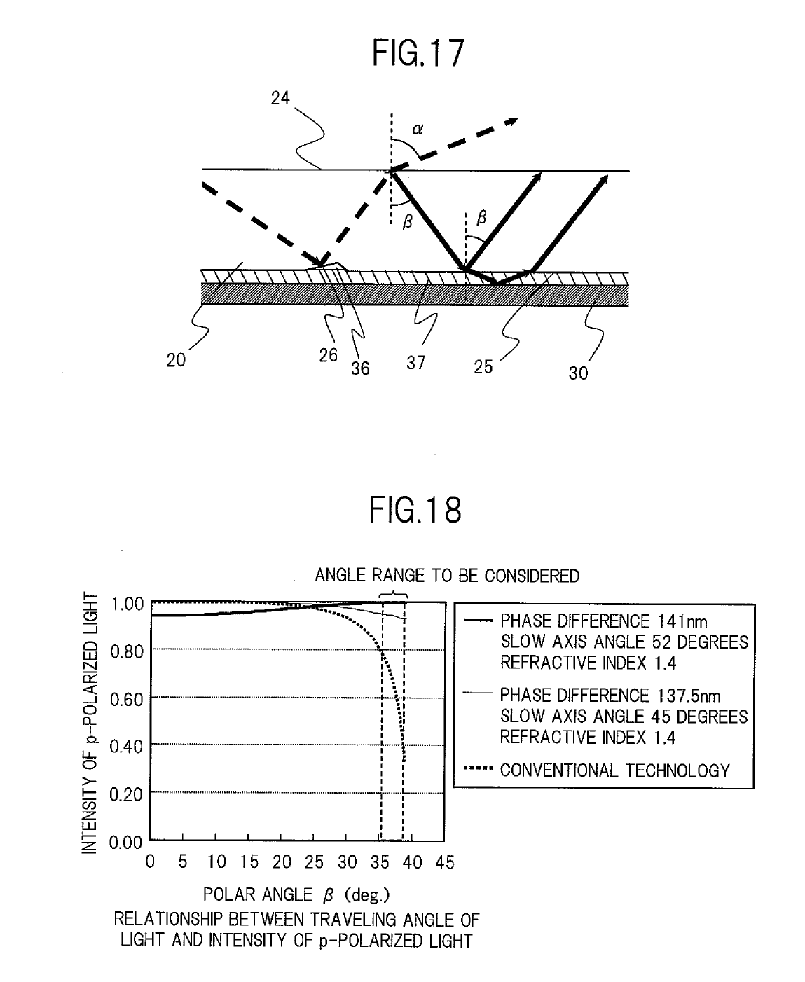

FIG. 17 is a partial cross sectional view illustrating a structure of the light guide plate 20 and the reflector 30 of the illuminating device 1 according to the embodiment of the present invention. As illustrated in FIG. 17, a transparent member 37 having a refractive index lower than that of the light guide plate 20 and higher than that of air may be disposed between the rear surface 25 of the light guide plate 20 and the reflector 30 (Embodiment 3).

On the rear surface of the light guide plate 20, a minute inclined surface portion 26 is formed to change a traveling angle of light propagating through the light guide plate 20. The inclined surface portion 26 is concaved inside the light guide plate in order to suppress losses caused by reflection on the inclined surface portion 26. It is desirable to provide a space 35 with the transparent member 37 and the inclined surface portion 26.

For the transparent member 37, a member whose visible light absorption is small and whose refractive index is lower than that of the light guide plate 20 and higher than that of air is selected. This is because the inclusion of the transparent member having a refractive index lower than that of the light guide plate 20 between the rear surface 25 of the light guide plate 20 and the reflector 30 causes a part of the light propagating through the light guide plate 20 to be subjected to total internal reflection on an interface between the rear surface 25 of the light guide plate 20 and the transparent member, enabling suppression of light losses caused by reflection of the reflector. The inclusion of the transparent member having a refractive index higher than that of air suppresses changes in polarized light conversion efficiency with respect to changes in distance between the rear surface 25 of the light guide plate 20 and the reflector 30, enabling realization of more stable and higher polarized light conversion efficiency.

For example, when polycarbonate having a refractive index of 1.5705 is used for the light guide plate 20, a refractive index Ntm of the transparent member 37 is selected from a range of from 1<Ntm<1.5705.

When a value of a refractive index of the transparent member 37 is smaller, a change in polarized light conversion efficiency becomes larger with respect to a change in distance between the rear surface 25 of the light guide plate 20 and the reflector 30 (in other words, a change in thickness of the transparent member 37). On the other hand, when a refractive index of the transparent member 37 is higher, a probability of reflection of light propagating through the light guide plate 20 by the reflector 30 becomes higher, and hence a loss of light propagating through the light guide plate 20 is increased.

In other words, there is a trade-off relationship between a loss of light propagating through the light guide plate 20 and stability of polarized light conversion efficiency. This trade-off relationship changes depending on an area or a thickness of the light guide plate 20, and hence an optimal refractive index Ntm cannot categorically be determined. However, in view of practical use of a material, a low refractive index is about 1.3 when a fluorine-contained material is used. For a high refractive index, when an acrylic resin having a refractive index of about 1.46 to 1.6 is used for the light guide plate 20, it is practical to select a refractive index Ntm of the transparent member 37 from a range of 1.3≦Ntm≦1.45. For the reflector 30, a reflective member having high reflectance and having a specular reflective surface formed on the support base material such as a resin plate or a polymer film may be used. The reflective surface may be formed by, for example, forming a metal thin film such as aluminum or silver having high reflectance on the support base material by an evaporation method or a sputtering method, forming a dielectric multilayer on the support base material so as to serve as an increase reflective film, or coating the support base material with a light reflective paint. The reflective surface may be formed of a plurality of transparent media of different refractive indexes which are laminated, to thereby function as the reflector 30.

The reflector 30 is disposed in the rear surface 25 of the light guide plate 20 via the transparent member 37. For the transparent member 37, a transparent material functioning as a transparent adhesive material having a refractive index lower than that of the light guide plate 20 may used, to thereby fix the reflector 30 to the rear surface 25 of the light guide plate 20.

Alternatively, the reflector 30 may be directly formed on the transparent member 37 formed beforehand on the rear surface 25 of the light guide plate 20. In this case, the reflector 30 may be realized by forming a metal thin film such as aluminum or silver having high reflectance on the transparent member 37 by an evaporation method or a sputtering method. Alternatively, the reflector 30 may be formed by forming a dielectric multilayer which is to serve as an increase reflective film or applying a light reflective paint.

FIG. 18 is a graph illustrating a relationship between a traveling angle β of light (wavelength of 550 nm) propagating through the light guide plate 20 and intensity of p-polarized light. In FIG. 18, data indicated by the thick line and the thin line correspond to a case where in the structure of FIG. 17, a refractive index of the transparent member 37 is 1.4 and a refractive index of the light guide plate 20 is 1.5705. The dotted line indicates a case of the conventional technology. As conditions of a birefringence of the light guide plate 20, a case where a phase difference is 141 nm and a slow axis angle is 52 degrees and a case where a phase difference is 137.5 nm and a slow axis angle is 45 degrees are respectively indicated by the thick line and the thin line in FIG. 18.

As illustrated in FIG. 18, when the refractive index of the transparent member 37 is 1.4 and the conditions of the birefringence of the light guide plate 20 are the phase difference of 141 nm and the slow axis angle of 52 degrees, among traveling angles β of light propagating through the light guide plate 20, within an angle range of from 35 to 39 degrees to be taken into consideration, intensity of p-polarized light becomes approximately 1.0, and hence conversion from s-polarized light into p-polarized light may be realized with extremely high efficiency. As a result, light output from the light guide plate 20 contains more p-polarized light components, realizing the illuminating device 1 capable of outputting light which contains more desired linearly polarized light components.

When intensity of p-polarized light is 0.9 or more, practically useful effects may be obtained, and hence the present invention does not exclude this range. Thus, when the refractive index of the transparent member 37 is 1.4, even if the conditions of the birefringence of the light guide plate 20 are the phase difference of 137.5 nm and the slow axis angle of 45 degrees, among traveling angles β of light propagating through the light guide plate 20, within an angle range (35 to 39 degrees) to be taken into consideration, intensity of p-polarized light may be set to 0.9 or more.

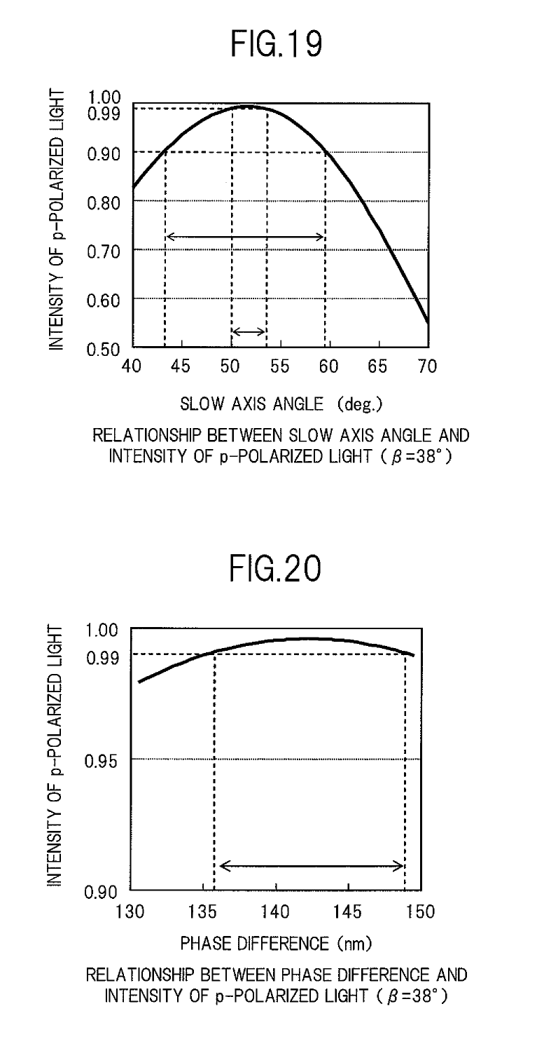

FIG. 19 is a graph illustrating a relationship between a slow axis angle θ of the light guide plate 20 and intensity of p-polarized light with respect to light of a traveling angle β=38 degrees when a refractive index of the transparent member 37 is 1.4 and a phase difference of the light guide plate 20 is 137.5 nm in light with a wavelength of 550 nm.

In FIG. 19, an optimal condition of a slow axis angle of the light guide plate 20 is about 52 degrees. When intensity of p-polarized light is 0.99 or more, effects substantially similar to those of the optimal condition may be obtained. Hence, a desirable range of slow axis angles of the light guide plate 20 when the transparent member 37 having the refractive index of 1.4 is interposed between the reflector 30 and the light guide plate 20 is a range of from 50 to 53 degrees. When intensity of p-polarized light is 0.9 or more, practically useful effects are obtained. Thus, in this case, a range of slow axis angles of the light guide plate 20 which provides practically useful effects when the transparent member 37 having the refractive index of 1.4 is interposed between the reflector 30 and the light guide plate 20 is a range of from 44 to 59 degrees.

FIG. 20 is a graph illustrating a relationship between a phase difference of the light guide plate 20 and intensity of p-polarized light with respect to light of a traveling angle β=38 degrees when the refractive index of the transparent member 37 is 1.4 and the slow axis angle θ of the light guide plate 20 is 52 degrees in light with a wavelength of 550 nm.

In FIG. 20, an optimal condition of the phase difference of the light guide plate 20 is 141 to 142 nm. This value is quarter wavelength×1.025 to quarter wavelength×1.033 with respect to the wavelength 550 nm having high relative luminous efficiency in photopic vision. The wavelength 550 nm is focused on in this judgment. When intensity of p-polarized light is 0.99 or more, effects substantially similar to those of the optimal condition are obtained, and hence a desirable range of phase differences of the light guide plate 20 is a range of from about 135.5 nm to 149 nm. This range is a range of from quarter wavelength×0.98 to quarter wavelength×1.08 with respect to the wavelength 550 nm focused on in this judgment.

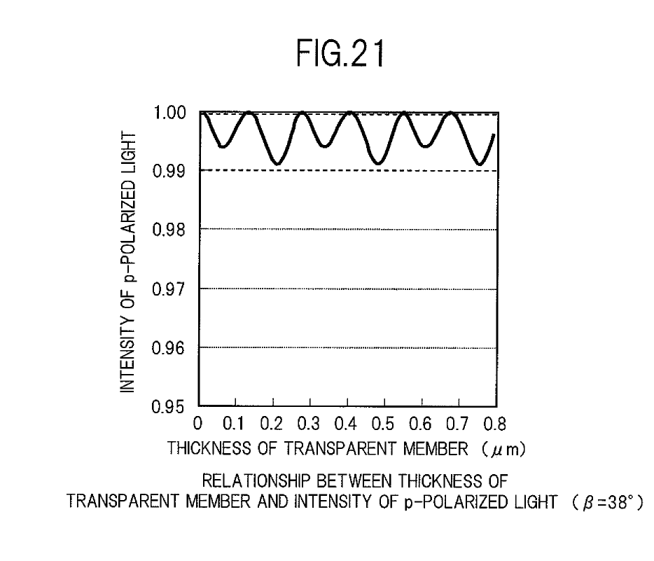

FIG. 21 is a graph illustrating a relationship between the thickness of the transparent member 37 and intensity of p-polarized light with respect to light of a traveling angle β=38 degrees when the refractive index of the transparent member 37 is 1.4, the slow axis angle θ of the light guide plate is 52 degrees, and the phase difference is 142 nm in light with a wavelength of 550 nm. Under these conditions, as illustrated in FIG. 21, even when the thickness of the transparent member 37, that is, a distance between the rear surface 25 of the light guide plate and the reflector 30, changes, a value of intensity of p-polarized light is maintained at 0.99 or more. In other words, even if no particular management is performed for the distance between the rear surface 25 of the light guide plate and the reflector 30, conversion from s-polarized light into p-polarized light may be realized with high efficiency. Thus, for example, even when manufacturing variation causes a change in distance between the rear surface 25 of the light guide plate 20 and the reflector 30, as light output from the light guide plate 20, light which contains more p-polarized light components is stably obtained. As a result, an illuminating device which outputs light containing more desired linearly polarized light components may be produced more reliably.

As a refractive index of the transparent member 37 is closer to a refractive index of the light guide plate 20, a change in intensity of p-polarized light caused by a difference in thickness of the transparent member 37 is smaller. Thus, for example, when the refractive index of the transparent member 37 is 1.45, if the slow axis angle θ is set to 52 degrees, and a phase difference is set to 141 to 142 nm, irrespective of a thickness of the transparent member 37, intensity of p-polarized light becomes 0.99 or more, providing high effects. In other words, even when the refractive index of the transparent member 37 is 1.45, high polarized light conversion effects may be obtained under the same conditions of the slow axis angle θ and the phase difference as those when the refractive index of the transparent member 37 is 1.4.

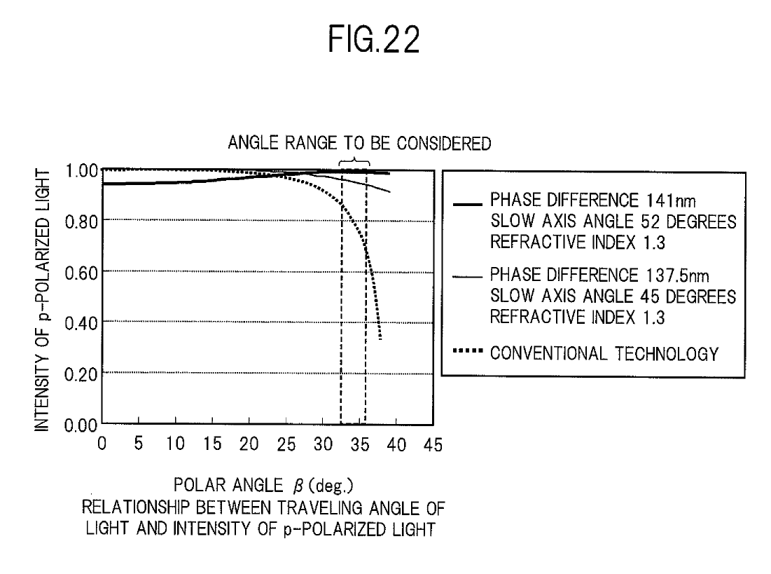

FIG. 22 is a graph illustrating a relationship between the traveling angle β of light (wavelength 550 nm) propagating through the light guide plate and the intensity of p-polarized light. FIG. 22 illustrates the relationship between the light traveling angle β and the intensity of p-polarized light when the refractive index of the transparent member 37 is 1.3 and the refractive index of the light guide plate is 1.5705 in the above-mentioned structure of FIG. 17, and includes a case of the conventional technology (dotted line) for comparison. Concerning conditions of the birefringence of the light guide plate, FIG. 22 illustrates a case where the phase difference is 141 nm and the slow axis angle θ is 52 degrees (thick line) and a case where the phase difference is 137.5 nm and the slow axis angle θ is 45 degrees (thin line).

As illustrated in FIG. 22, when the refractive index of the transparent member 37 is 1.3, and the conditions of the birefringence of the light guide plate 20 are the phase difference of 141 nm and the slow axis angle θ of 52 degrees, among traveling angles β of light propagating through the light guide plate 20, within an angle range of from 35 to 39 degrees to be taken into consideration, intensity of p-polarized light has a large value, and hence conversion from s-polarized light into p-polarized light may be realized with high efficiency. As a result, light output from the light guide plate 20 contains more p-polarized light components, realizing the illuminating device 1 capable of outputting light which contains more desired linearly polarized light components.

When intensity of p-polarized light is 0.9 or more, practically useful effects may be obtained, and hence the present invention does not exclude this range. Thus, when the refractive index of the transparent member 37 is 1.3, even if the conditions of the birefringence of the light guide plate 20 are the phase difference of 137.5 nm and the slow axis angle θ of 45 degrees, among traveling angles β of light propagating through the light guide plate 20, within an angle range (35 to 39 degrees) to be taken into consideration, intensity of p-polarized light may be set to 0.9 or more.

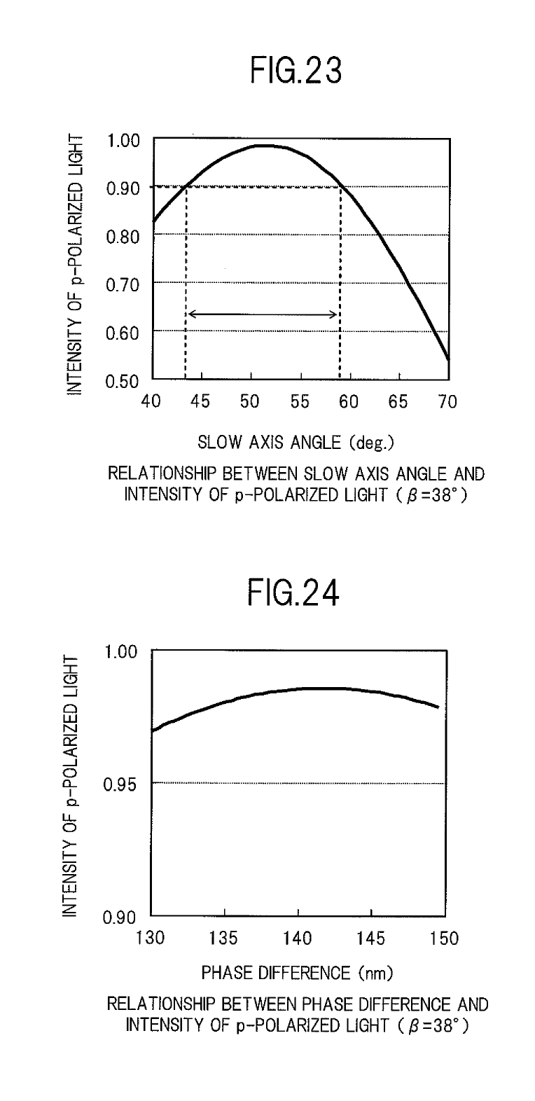

FIG. 23 is a graph illustrating a relationship between the slow axis angle θ of the light guide plate 20 and the intensity of p-polarized light with respect to light of a traveling angle β=38 degrees when the refractive index of the transparent member 37 is 1.3 and a phase difference of the light guide plate 20 is 137.5 nm in light with a wavelength of 550 nm.

In this case, an optimal condition of the slow axis angle θ of the light guide plate 20 is 51 to 52 degrees. When intensity of p-polarized light is 0.9 or more, practically useful effects may be obtained, and hence a range of the slow axis angles of the light guide plate 20 of embodiment 3 is a range of from 44 to 59 degrees.

FIG. 24 is a graph illustrating a relationship between the slow axis angle θ of the light guide plate 20 and the intensity of p-polarized light with respect to light of a traveling angle β=38 degrees when the refractive index of the transparent member 37 is 1.3 and the phase difference of the light guide plate 20 is 52 degrees in light with a wavelength of 550.

In this case, an optimal condition of the phase difference of the light guide plate 20 is 141 to 142 nm. This value is quarter wavelength×1.025 to quarter wavelength×1.033 with respect to the wavelength 550 nm having high relative luminous efficiency in photopic vision. The wavelength 550 nm is focused on in this judgment. In both cases where the refractive indexes of the transparent member 37 are 1.4 and 1.3, when the slow axis angle θ and the phase difference similarly set in the light guide plate 20, light of high intensity of p-polarized light may be obtained.

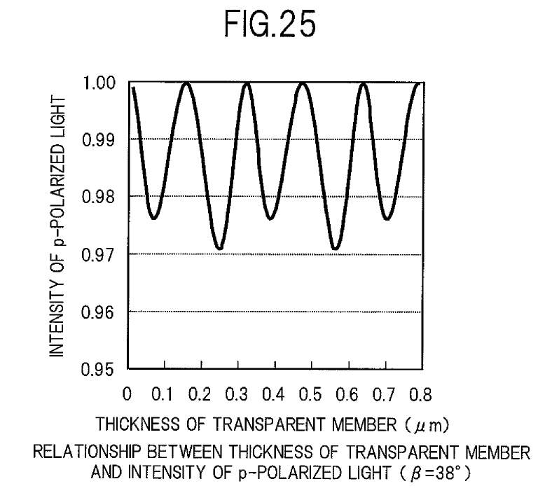

FIG. 25 is a graph illustrating a relationship between the thickness of the transparent member 37 and the intensity of p-polarized light with respect to light of a traveling angle β=38 degrees when the refractive index of the transparent member 37 is 1.3, the slow axis angle θ of the light guide plate is 52 degrees, and the phase difference is 141 nm in light with a wavelength of 550 nm. Under these conditions, as illustrated in FIG. 25, even when the thickness of the transparent member 37, that is, a distance between the rear surface 25 of the light guide plate and the reflector 30, changes, a value of intensity of p-polarized light is maintained at 0.97 or more. In other words, the interpolation of the transparent member 37 enables conversion of s-polarized light into p-polarized light with high efficiency even without any special management for a distance between the rear surface 25 of the light guide plate and the reflector 30. Thus, for example, even when manufacturing variation causes a change in distance between the rear surface 25 of the light guide plate 20 and the reflector 30, as light output from the light guide plate 20, light which contains more p-polarized light components is stably obtained. As a result, an illuminating device which outputs light containing more desired linearly polarized light components may be produced more reliably.

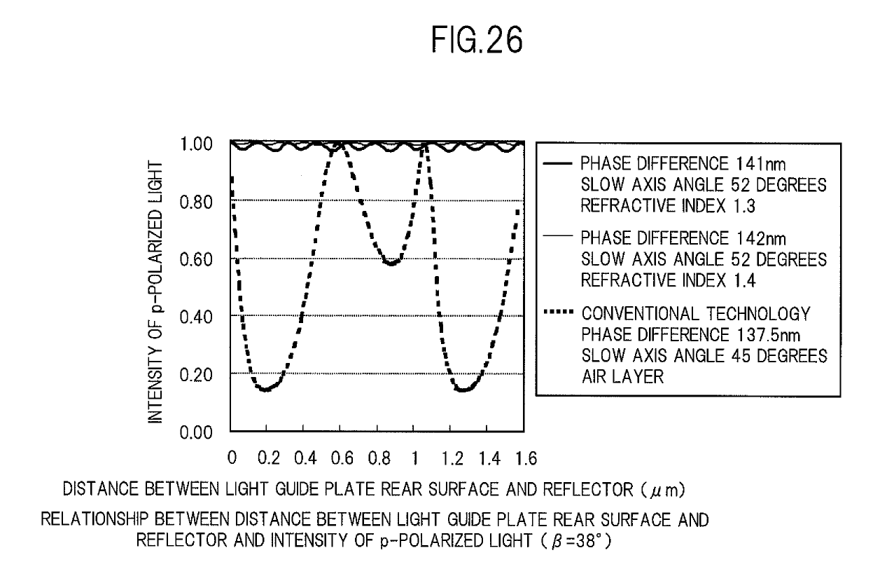

FIG. 26 is a graph, for light with a wavelength of 550 nm and a traveling angle β=38 degrees, illustrating a relationship between the distance between the rear surface of the light guide plate 20 and the reflector 30 and the intensity of p-polarized light. In FIG. 26, a case where the refractive index of the transparent member 37 is 1.3, the slow axis angle θ of the light guide plate 20 is 52 degrees, and the phase difference is 141 nm is indicated by the thick line, a case where the refractive index of the transparent member 37 is 1.4, the slow axis angle θ of the light guide plate is 52 degrees, and the phase difference is 142 nm is indicated by the thin line, and a case of the conventional technology for comparison is indicated by the dot line. In the case of the conventional technology indicated by the dot line, there is an air layer provided between the rear surface 25 of the light guide plate 20 and the reflector 30, the slow axis angle θ of the light guide plate 20 is 45 degrees, and the phase difference is 137.5 nm.

As illustrated in FIG. 26, even when the thickness of the transparent member 37 (that is, the distance between the rear surface 25 of the light guide plate and the reflector 30) changes, a value of intensity of p-polarized light is maintained high. Thus, for example, even when the refractive index of the transparent member 37 takes a low value of 1.3, conversion from s-polarized light into p-polarized light may be stably realized at an extremely high level, as compared with the conventional technology.

When the transparent member 37 is provided between the rear surface 25 of the light guide plate 20 and the reflector 30, a part of light propagating through the light guide plate 20 is subjected to total internal reflection on the interface between the rear surface 25 of the light guide plate 20 and the transparent member 37. Hence, light losses are further suppressed as compared to a case where the reflector 30 is directly disposed on the rear surface 25 of the light guide plate 20. When the refractive index of the transparent member 37 is 1.3, that is, a refractive index difference from the light guide plate 20 is about 0.27, as illustrated in FIG. 25, intensity of p-polarized light is maintained at a high value of 0.97 or more irrespective of the thickness of the transparent member 37. Thus, in order to stably obtain high polarized light conversion efficiency, it may be set a difference in refractive index between the transparent member 37 and the light guide plate 20 to 0.27 or less.

Embodiments 1 to 3 of the light guide plate 20 and the reflector 30 have been described. From the viewpoint of reducing light losses and manufacturing, Embodiment 3 is preferable. The birefringence is imparted to the light guide plate 20 in view of light obliquely propagating through the light guide plate 20 as described above. Thus, the birefringence is provided so that the slow axis can form an angle of 45 degrees or more anticlockwise (or clockwise) with respect to the longitudinal direction of the side surface where the light source is disposed, or the phase difference larger than a quarter of a focused wavelength may be obtained. The slow axis angle and the phase difference are set in accordance with an interval between the reflector 30 and the rear surface 25 of the light guide plate 20 or a refractive index of the transparent medium interposed therebetween. In the above-mentioned case, the phase difference is determined based on the ray with a wavelength of 550 nm having high visibility (λ=550 nm). However, the phase difference may be determined based on a peak wavelength in emission distribution or spectral characteristics of the light source 10. In the above-mentioned case, the front surface 24 and the rear surface 25 of the light guide plate 20 are formed in parallel to each other and, for example, as illustrated in FIG. 5, an incident angle β to the front surface 24 and an incident angle β to the rear surface 25 are equal, and hence these are set as the traveling angles β. However, the rear surface 25 may be slightly inclined with respect to the front surface 24 to be formed into a wedge shape. In this case, the incident angle β to the front surface 24 and the incident angle β to the rear surface 25 are not exactly equal, unlike in the case of FIG. 5. However, the inclination of the rear surface 25 with respect to the front surface 24 is limited to a slight intensity, and hence, as in the case of the above, intensity of p-polarized light may be increased by imparting a birefringence to the light guide plate 20.

[Prism Sheet Formed on Rear Surface of Light Guide Plate]

Next, a structure on the front surface side of the light guide plate 20 is described. As illustrated in FIG. 1, on the front surface side of the light guide plate 20, a prism sheet 50 is disposed to cover the entire surface. The prism sheet 50 functions as light control means for changing the traveling angle of light output from the light guide plate 20. In this embodiment, the prism sheet 50 also functions to increase a degree of polarization of light output from the light guide plate 20 to be made incident on the prism sheet 50 from a rear side of the prism sheet 50.

The prism sheet 50 includes at least two inclined surfaces, and a plurality of prism arrays having ridge lines extending in one direction. As illustrated in FIG. 2, the direction of the ridge line of each prism is in a direction (direction where an azimuth angle is 0 degrees) parallel to a longitudinal direction of the side surface where the light source 10 of the light guide plate 20 is disposed. The prism sheet 50 is disposed so that a forming surface of the prism arrays faces the front surface side (liquid crystal display panel side). A shape of the prism is formed so that the traveling angle of light output from the light guide plate 20 with having an angle at which a luminance or luminous intensity reaches a peak may be refracted almost in a front direction (direction vertical to the light outputting surface of the light guide plate 20) when the light is made incident. The prism sheet 50 is made of a transparent medium which produces no phase difference for p-polarized light when the light output from the light guide plate 20 with having an angle at which a luminance or luminous intensity reaches a peak passes through the prism sheet 50.

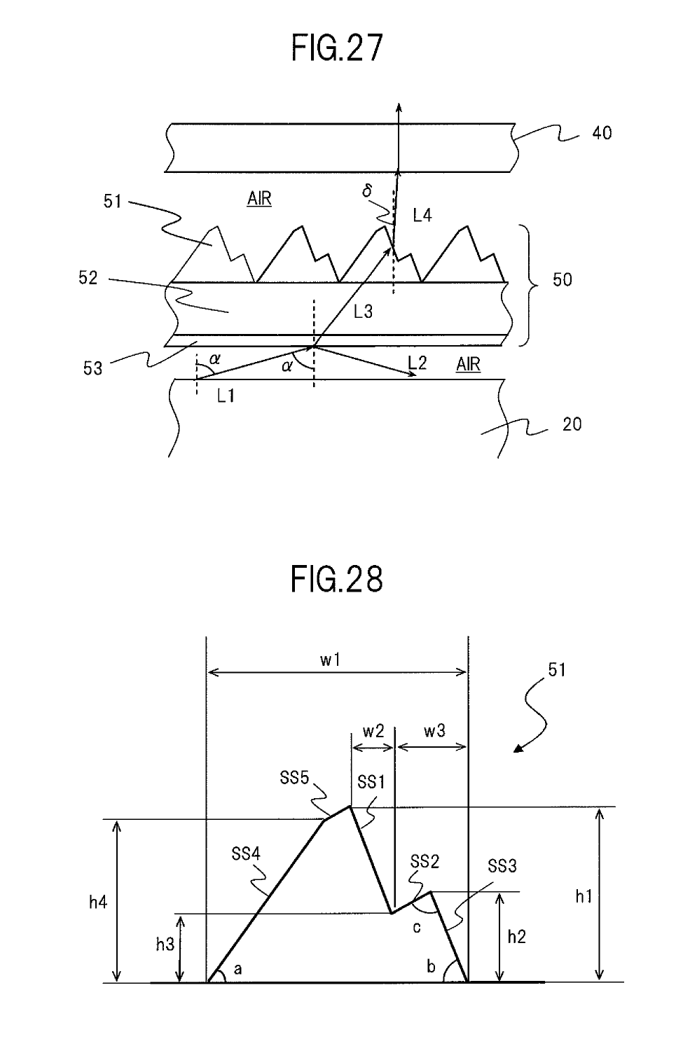

Next, referring to FIGS. 27 and 28, a specific example of the prism sheet 50 is described. FIG. 27 is a schematic cross sectional view illustrating a part of the illuminating device 1 according to the embodiment of the present invention, that is, an enlarged explanatory view particularly illustrating the prism sheet 50 and its peripheral portions in the cross sectional view of FIG. 1. FIG. 28 is a cross sectional view illustrating an example of a detailed shape of a prism 51 formed on the front surface of the prism sheet 50 according to the embodiment of the present invention.

For the prism sheet 50, use of a sheet which uses a transparent film as a base material 52 and includes prisms 51 formed in arrays on its front surface is practical in view of productivity and industrial usability. For the base material 52, a transparent medium which produces no phase difference in p-polarized light components of light passed through the prism sheet 50 is used. The transparent medium used for the base material 52 is used in order to suppress losses of the p-polarized light components, which is otherwise caused by a change in p-polarized light passed through the prism sheet 50.

Specifically, for example, as the base material 52, an optically isotropic transparent medium such as a triacetylcellulose film or a non-stretched polycarbonate film having almost no refractive index anisotropy at least in plane may be used. Alternatively, a transparent medium provided with a uniaxial anisotropy of a refractive index in a plane by stretching a film made of a polycarbonate resin or an olefin resin in one direction may be used. In this case, however, in order to prevent generation of a phase difference in p-polarized light passed through the prism sheet 50, when the prism sheet 50 is disposed, it is important to set an angle of the slow axis of the base material 52 to an azimuth angle θ=0 degrees or θ=90 degrees.

As the base material 52 of the prism sheet 50, it is extremely useful from an industrial point of view to use a polyethylene terephthalate (PET) film which is relatively inexpensive and easy to be handled. However, the PET film has a biaxial anisotropy. Thus, when the PET film is used as the base material 52, special care is necessary to prevent generation of a phase difference in p-polarized light passed through the prism sheet 50.

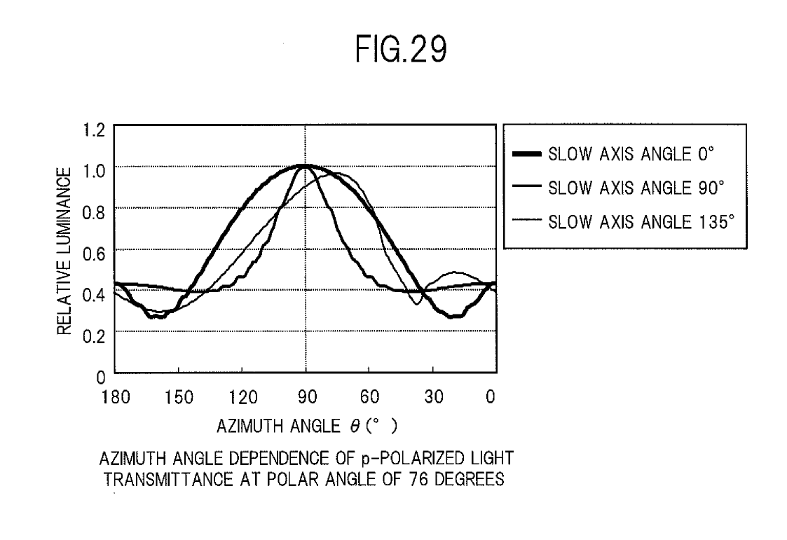

FIG. 29 illustrates a simulation result of transmittance of p-polarized light at a polar angle α=76 degrees when the p-polarized light (that is, linearly polarized light where an electric vector vibration direction of light is included in plane including an azimuth angle θ=90 degrees) is made incident on a biaxial anisotropic transparent medium (main refractive indexes: nx=1.68, ny=1.62, and nz=1.47, and thickness 50 μm) assuming a PET film. More specifically, FIG. 29 illustrates a relationship between the traveling angle (azimuth angle) of the incident light and the transmittance of the light represented by a relative luminance. Further, in FIG. 29, three different patterns, that is, the azimuth angle of 135 degrees, the azimuth angle of 0 degrees, and the azimuth angle of 90 degrees are illustrated as a condition of the slow axis angle of the transparent medium. As illustrated in FIG. 29, in the case of the transparent medium having a biaxial anisotropy, the p-polarized light components are not reduced due to the phase difference generated in the p-polarized light which travels in the azimuth angle of 90 degrees at a predetermined polar angle, when the slow axis angle is set to 0 degrees or 90 degrees. Further, when the slow axis angle is set to 0 degrees, the phase difference generated in the p-polarized light becomes less within a wider range of the azimuth angle including the azimuth angle of 90 degrees. Accordingly, a loss of the p-polarized light is controlled.

When the transparent medium is used as the base material 52 of the prism sheet 50, an angle range to be studied with respect to the light which passes through the prism sheet 50 is the azimuth angle θ of 90 degrees with a margin of ±15 degrees and the viewing angle α within a range between 60 and 80 degrees when considering an angle distribution of the light which is output from the light guide plate 20. Therefore, when the transparent medium of the biaxial anisotropy such as the PET film is used as the base material 52 of the prism sheet 50, it is desired that the slow axis angle of the transparent medium be set to the azimuth angle of 0 degrees or 90 degrees, that is, that the direction of the ridge lines of the prisms 51 be made to be in parallel with or orthogonal to the slow axis angle. Further, as described above, if the slow axis angle is set to 0 degrees, the phase difference generated in the p-polarized light becomes less within a wider range of the azimuth angle including the azimuth angle of 90 degrees. Accordingly, more p-polarized light may be output from the prism sheet 50. Therefore, it is desired that the direction of the ridge lines of the prisms 51 be made to be in parallel with the slow axis angle. To produce better effect, it is desired that the direction of the ridge lines of the prisms and the slow axis angle be made to satisfy the above-mentioned conditions. However, fluctuation of quality may occur in actually manufactured products, resulting in causing a shift of the angle. In this case, variation in angle with a margin of about ±5 degrees is acceptable.

When the transparent medium of the biaxial anisotropy is used as the base material 52 of the prism sheet 50 as described above, there is produced a large difference in effect between when the slow axis angle is 0 degrees and when the slow axis angle is 90 degrees. On the contrary, when the transparent medium of the uniaxial anisotropy is used as the base material 52 of the prism sheet 50, a loss of the p-polarized light is suppressed in the same manner both when the slow axis angle is 0 degrees and when the slow axis angle is 90 degrees.

FIG. 28 is a cross sectional view illustrating an example of the specific shape of the prism 51 formed on the front surface of the prism sheet 50. In this embodiment, in order to suppress a color variation caused when a viewing angle α (polar angle α) is changed in the azimuth angle which is orthogonal to the direction of the ridge lines of the prisms 51, the following means is employed. More specifically, a cross sectional shape of the prism 51 includes a plurality of inclined surfaces with two main inclination angles. With respect to the vertex of the prism, a portion relatively far from the light sources includes at least three inclined surfaces, and at least one of the three inclined surfaces is inclined in an opposite direction in comparison with the other inclined surfaces when viewing from the light outputting surface of the prism sheet 50.

The above-mentioned two main inclination angles include an angle of the inclined surface which is relatively far from the light sources with respect to the vertex of the prism 51 and an angle of the inclined surface which is relatively near the light sources with respect thereto. More specifically, the two main inclination angles include an inclination angle at which the light is refracted in the front direction of the prism sheet 50 and an inclination angle at which the light is seldom made incident on the prism sheet 50 directly, when the light, which is output from the light guide plate 20 and has the angle at which the luminance or the luminous intensity becomes the maximum value, is made incident on the prism sheet 50. In this embodiment, the prism 51 has a cross sectional shape which includes five inclined surfaces (SS1 through SS5) combined with one another. When the light, which is output from the light guide plate 20 and has the angle at which the luminance or the luminous intensity becomes the maximum value, is made incident on the prism sheet 50, the inclined surface with a main inclination angle which the above-mentioned light is made incident on corresponds to SS1 and SS3. Further, when the light, which is output from the light guide plate 20 and has the angle at which the luminance or the luminous intensity becomes the maximum value, is made incident on the prism sheet 50, the inclined surface with a main inclination angle which the light is not made incident on corresponds to SS4. The inclined surface SS2 is an inclined surface that the light is made incident on, which is output from the light guide plate 20 and has the angle at which the luminance or the luminous intensity reaches a peak. However, the inclined surface SS2 refracts the light in a direction different from ones by the inclined surfaces SS1 and SS3, and is inclined in an opposite direction from the inclined surfaces SS1 and SS3. If a top end of the prism 51 is made into a sharp angle, a defect tends to occur in manufacturing the prism 51, and hence the inclined surface SS5 is formed in order to avoid the sharp angle of the top end of the prism 51.

Practical pitches between the prism arrays and practical heights of the prisms are about several tens μm. Specific size and inclination angle of the prism 51 may be selected in consideration with an optical simulation or the like in accordance with the refractive index of the transparent medium forming the base material 52 of the prism sheet 50 and the prisms 51.

Further, in this embodiment, a width w1 and a height h1 of the entire prism are about 35 μm and about 25 μm, respectively. When the light, which is output from the light guide plate 20 and has the angle at which the luminance or the luminous intensity becomes the maximum value (reaches a peak), is made incident on the prism sheet, among the main inclination angles, an inclination angle b of the inclined surface on which the light is refracted in the front direction of the prism sheet is about 69 degrees, and an inclination angle a of the inclined surface that the light, which is output from the light guide plate 20 and has the angle at which the luminance or the luminous intensity reaches a peak, is not made incident on is about 58 degrees. Other sizes defined in FIG. 28 are a width w2 of about 6 μm, a width w3 of about 12 μm, a height h2 of about 13 μm, a height h3 of about 9 μm, a height h4 of about 25 μm, and an angle c of 80 degrees.

When the prism 51 is made into the above-mentioned shape, if an average refractive index of the base material 52 of the prism sheet 50 is set to 1.65 and the refractive index of the prism 51 is set to 1.68, an angle δ of the light which is output from the inclined surfaces SS1 and SS3 of the prism sheet 50 becomes 0.5 degrees with respect to the light which is output from the light guide plate 20 and has an angle α of 77 degrees, that is, the light is output to about a front of the illuminating device 1. Alternatively, if the average refractive index of the base material 52 is set to 1.65 and the refractive index of each prism 51 is set to 1.64, the angle δ of the light, which is output from the inclined surfaces 851 and SS3 of the prism sheet 50, becomes 0.2 degrees with respect to the light having an angle α of 68 degrees at which the luminous intensity of the light output from the light guide plate 20 becomes the maximum value, that is, the light is output to about the front of the illuminating device 1.

A part of the light which is output from the light guide plate 20 and has the angle at which the luminance and the luminous intensity becomes the maximum value is made incident on the prism sheet 50 and then passes through the inclined surface SS2 when the light is output. At this time, most of the light which is output from the light guide plate 20 is refracted in the azimuth direction (azimuth angle of 270 degrees) where the light sources 10 are disposed. However, a part of the light, which passes through the inclined surface SS2, is refracted in the opposite azimuth direction (azimuth angle of 90 degrees). In this case, due to a wavelength dependence of the refractive index of the transparent medium which forms the prism sheet 50, parts of the color variation caused at the time of the refraction of the light are averaged. Accordingly, the color variation is caused due to the wave length dependence of the refractive index of the transparent medium, and hence such color variation may be controlled.

The prism 51 is made of an optically isotropic transparent medium or a transparent medium which does not generate the phase difference which is detrimental to the p-polarized light passing through the transparent medium. This is because, as in the base material 52 of the prism sheet 50, by reducing the loss of the p-polarized light components due to a change of the state of the p-polarized light which is output from the light guide plate 20 and passes through the prism sheet 50, light containing a higher ratio of p-polarized light components is output from the prism sheet 50.

Any transparent medium such as an ultraviolet curable resin or a thermosetting resin may be used as the transparent medium which forms the prism 51 as far as the transparent medium satisfies the above-mentioned conditions. Further, to realize a desired refractive index, the transparent medium may contain fine particles, such as titanium oxide particles, which are transparent and have a high refractive index, as required. In this case, it is desired that each of the fine particles have a diameter of a range about between several nm and several tens nm so as to minimize scattering of light at least with respect to a visible wavelength area.

S-polarized light high reflecting means 53 is provided on the rear surface of the prism sheet 50, as required. The s-polarized light high reflecting means 53 is provided in order to reflect more s-polarized light components when the light, which is output from the light guide plate 20 and has an angle at which at least the luminance or the luminous intensity becomes the maximum value, is made incident on the prism sheet 50. In other words, as compared with a case where a rear surface of the prism sheet 50 is formed only of the base material 52 which is planar and in parallel with the light outputting surface of the light guide plate 20 without the s-polarized light high reflecting means 53, the s-polarized light high reflecting means 53 has a function of reflecting more s-polarized light components of the light which is output from the light guide plate 20 at a predetermined angle. It is not necessary that the reflectance is different between the s-polarized light and the p-polarized light with respect to the light which perpendicularly is made incident on the prism sheet 50. In order to realize such a configuration that more s-polarized light components are reflected with respect to the light perpendicularly being incident on the prism sheet 50, it is necessary, for example, to provide a plurality of layers having different birefringences laminated on one another. In this case, a thickness of the prism sheet 50 is increased, which results in an increase in cost. On the other hand, in this embodiment, the s-polarized light high reflecting means 53 may have such a configuration that more s-polarized light components are reflected particularly with respect to the light which is output from the light guide plate 20 and has the angle at which at least the luminance or the luminous intensity becomes the maximum value. In other words, the s-polarized light high reflecting means 53 may be configured so as to reflect more s-polarized light components with respect to the light which obliquely is made incident on the prism sheet 50. The s-polarized light high reflecting means 53 may be realized, as described below, by a format ion of a single layer for the prism sheet 50 or a modification of a shape of a surface of the prism sheet 50, and hence an increase in thickness of the prism sheet 50 or an increase in cost may be suppressed by the configuration of the s-polarized light high reflecting means 53 as compared with the configuration in which more s-polarized light components are reflected with respect to the light perpendicularly incident on the prism sheet 50. As the s-polarized light high reflecting means 53, one layer having a refractive index higher than that of the base material 52 of the prism sheet 50 may be formed so that its thickness ds can satisfy the following condition with respect to an angle at which a luminance or luminous intensity of light output from the light guide plate 20 becomes the maximum value. That is, a thickness (film thickness) d may satisfy the following expression (4), where ns denotes a refractive index of the s-polarized light high reflecting means 53, and ∈ denotes an angle of, among lights output from the light guide plate 20, light incident on the prism sheet 50 at an angle at which a luminance or luminous intensity becomes the maximum value and propagates through the s-polarized light high reflecting means 53 (inclined angle from a direction vertical to the light outputting surface of the light guide plate 20).

[Expression 4]

ds=λ/(4·ns·cos ∈)(2m+1) (4)

In the expression, λ denotes a wavelength of light, and m is an integer. The wavelength λ is a wavelength of a visible light. For example, a value of 550 nm having high luminous efficiency in photopic vision may be used. A thickness ds of the s-polarized light high reflecting means 53 may take a value obtained by setting a value of m to an integer of 1 or more. However, when a film thickness ds is larger, the influence of wavelength dependence of the refractive index of the transparent medium constituting the s-polarized light high reflecting means 53 is greater, and hence it is desirable to select a value calculated to be m=0 as a film thickness ds.

For the s-polarized light high reflecting means 53, the same material as that of the high refractive index layer formed on the front surface of the light guide plate may be used. When one layer is formed by a material having a refractive index higher than that of the base material 52 of the prism sheet 50 for the s-polarized light high reflecting means 53, if a refractive index ns of the transparent medium used for the s-polarized light high reflecting means 53 is higher, losses (reflection) of p-polarized light components when incident on the prism sheet 50 are reduced, and more s-polarized light components are reflected. Thus, as light transmitted through the prism sheet 50, light containing more p-polarized light components is obtained. In particular, by increasing a refractive index of the frontmost surface of the rear surface of the prism sheet 50, of light output from the light guide plate 20, with respect to an angle at which a luminance or luminous intensity becomes the maximum value, a state satisfying a condition of Brewster's angle or a state closer to the condition of Brewster's angle is set, to thereby eliminate or make extremely small reflection losses of p-polarized light components on the rear surface of the prism sheet 50.

S-polarized light reflected on the rear surface of the prism sheet 50 passes through the light guide plate 20 and the reflector 30 to be made incident on the prism sheet 50 again. When passing through the light guide plate 20, a polarization state of the light changes due to the birefringence of the light guide plate 20. This light contains p-polarized light components, and passes through the prism sheet 50 to be used as illuminating light. In other words, at least a part of s-polarized light reflected on the rear surface of the prism sheet 50 is converted into p-polarized light, and may be used as illuminating light. As a result, a light intensity of p-polarized light components may be increased.

However, when the refractive index ns of the transparent medium used for the s-polarized light high reflecting means 53 is higher, changes in reflectance of the p-polarized light and the s-polarized light become larger with respect to variance of a film thickness d, and hence a manufacturing margin is smaller. Thus, it is practical to increase the refractive index of the transparent medium used for the s-polarized light high reflecting means 53 within a range of from 0.2 to 0.7 with respect to the base material 52 of the prism sheet 50.

As illustrated in FIG. 1, a diffusion sheet 40 may be disposed on the front surface side of the prism sheet 50 when necessary. The diffusion sheet 40 functions to widen an output angle distribution by diffusing light output from the prism sheet 50 or to increase in-plane uniformity of a luminance. For the diffusion sheet 40, a sheet including convexo-concave patterns formed on a surface of a transparent polymer film such as polyethylene terephthalate (PET) or polycarbonate (PC), a sheet including a diffusion layer mixing translucent fine particles different in refractive index from a transparent medium in the transparent medium formed on a surface of a polymer film, a sheet provided with diffuseness by mixing bubbles in a plate or a film, or an opalescent member dispersing white pigments in a transparent member such as an acrylic resin may be used. The prism forming surface of the prism sheet 50 is easily damaged, and hence the diffusion sheet 40 may function as a protection layer of the prism sheet 50.

When a film such as PET or PC having an optical anisotropy is used for the diffusion sheet 40, in order to realize illuminating light where a light intensity of predetermined linearly polarized light components is large, it is important to maintain a state of p-polarized light output from the prism sheet 50 by setting an angle of its slow axis to an azimuth angle θ=0 degrees or 90 degrees.

[Liquid Crystal Display Device]

The illuminating device as illustrated in FIG. 1, which includes the light source 10, the light guide plate 20, the reflector 30, the prism sheet 50, and the diffusion sheet 40, has been described. Hereinafter, a liquid crystal display device configured by using the illuminating device as a backlight and disposing a liquid crystal display panel on the front surface of the light guide 20 or the like is described.

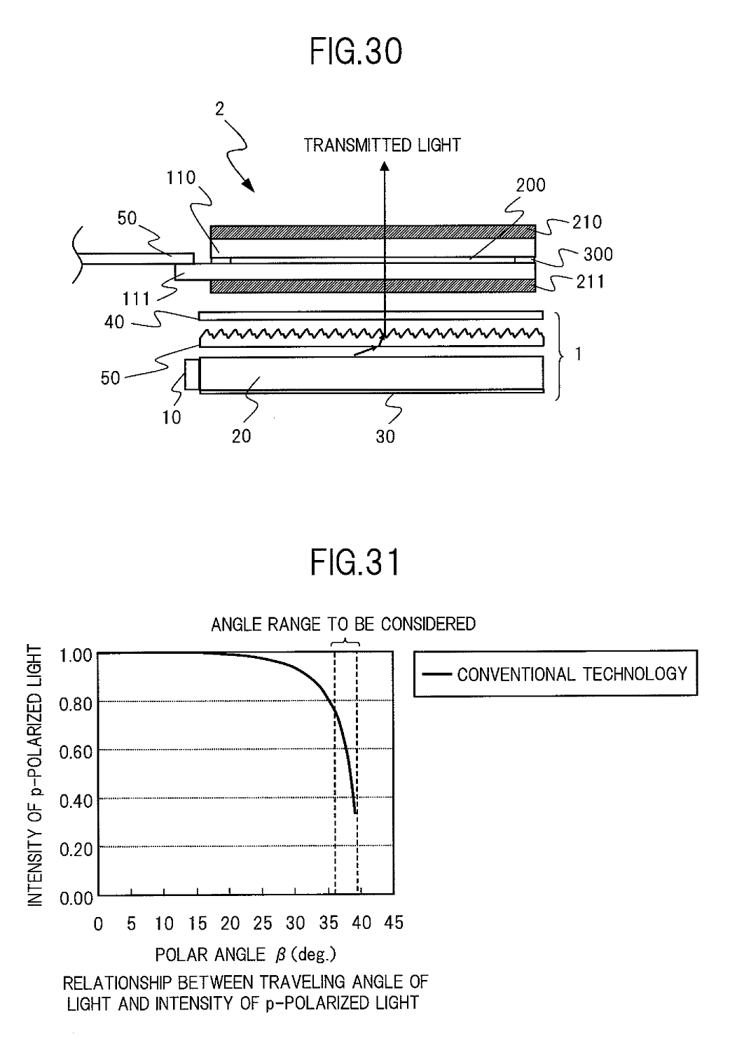

FIG. 30 is a cross sectional view schematically illustrating a configuration of the liquid crystal display device according to this embodiment.

The liquid crystal display device according to this embodiment includes a liquid crystal display panel 2 which displays an image by controlling the light intensity of transmitted light based on image information, and the illuminating device 1 which illuminates the liquid crystal display panel 2 from behind. As the liquid crystal display panel 2 may be used a liquid crystal display panel 2 which displays an image by adjusting the light intensity of transmitted light which is made incident on the liquid crystal display panel 2, in particular, a liquid crystal display panel 2 which has a long life and may perform matrix display. Specifically, the liquid crystal display panel 2 may be a transmissive or transflective type liquid crystal display panel 2, in which an image is displayed by adjusting the light intensity of transmitted light from the illuminating device 1 in combination with the illuminating device 1. The liquid crystal display panel 2 includes various systems such as a passive drive system and an active matrix drive system. Detailed description of the configurations or operations thereof is omitted here because those have already been publicly known.

Such a liquid crystal display panel 2 that includes a polarizer and displays image by controlling the polarization state of the light which is made incident on the liquid crystal layer is desired because an image of a high contrast ratio may be obtained with a relatively low driving voltage. A twisted nematic (TN) liquid crystal display panel, a super twisted nematic (STN) liquid crystal display panel, and an electrical controlled birefringence (ECB) liquid crystal display panel may be used as the liquid crystal display panel. An in-plane switching (IPS) liquid crystal display panel and a vertical aligned (VA) liquid crystal display panel, which are characterized by a wide viewing angle, may also be used. The liquid crystal display panel 2 may also be a transflective type liquid crystal display panel, which is an application example of the above-mentioned various liquid crystal display panels. In the following description, a case where the active matrix liquid crystal display panel is used as the liquid crystal display panel 2 is schematically described, but the present invention is not limited thereto.

The liquid crystal display panel 2 includes a first transparent substrate 110 and a second transparent substrate 111 which are made of flat transparent optically isotropic glass or plastic. The first transparent substrate 110 is formed such that a color filter and an alignment layer made of a polyimide series polymer (both not shown) are laminated one above the other. The second transparent substrate 111 is provided with electrodes, signal electrodes, scanning electrodes, and switching elements including thin film transistors and the like which form a plurality of pixels arranged in matrix, an alignment layer, and the like (both not shown).

The two transparent substrates 110 and 111 form a space therebetween such that alignment layer forming surfaces of the transparent substrates 110 and 111 are faced to each other and the respective peripheries of the alignment layer forming surfaces of the transparent substrates 110 and 111 are bonded through a frame shaped sealing member 300 under a state in which the transparent substrates 110 and 111 are constantly spaced to each other by using a spacer (not shown). Liquid crystal is injected into the space and sealed in the space, to thereby provide a liquid crystal layer 200. An orientation direction of a longitudinal axis of liquid crystal molecules, which form the liquid crystal layer 200, is defined by an orientation processing provided to the alignment layers formed on the two transparent substrates 110 and 111.

A first polarizer 210 and a second polarizer 211, respectively, are disposed on surfaces of the first transparent substrate 110 and the second transparent substrate 111, the surfaces opposite to the liquid crystal layer 200. The first polarizer 210 and the second polarizer 211 may be formed such that, for example, a triacetylcellulose protection layer is provided on both sides of a film which is imparted with a polarization function by having iodine adsorbed onto stretched polyvinylalcohol. Preferably, the first polarizer 210 and the second polarizer 211, respectively, are fixed to the first transparent substrate 110 and the second transparent substrate 111 via a transparent bond (not shown). A phase difference layer (not shown) may be appropriately provided between the polarizer and the transparent substrate according to a liquid crystal display mode of the liquid crystal display panel 2.

The liquid crystal display panel 2 includes a display area for forming a two-dimensional image by modulating the transmission of the light output from the illuminating device 1, within an area in which the second transparent substrate 111 and the first transparent substrate 110 overlap one another. The second transparent substrate 111 is larger than the first transparent substrate 110 and includes an area for receiving image information such as an image signal in the form of an electric signal from the outside in the area of the second transparent substrate 111 that is on a surface facing to the first transparent substrate 110, the area being not covered by the transparent substrate 110. In other words, the liquid crystal display panel 2 includes a flexible printed circuit (FPC) board 400 in the area on the second transparent substrate 111 where the first transparent substrate 110 is not overlapped, and is electrically connected to the outside through the FPC 400. In this area, a semiconductor chip (not shown) may be provided in order to allow the semiconductor chip to function as a driver, as required.

An orientation of the absorption axis of linearly polarized light of each of the first polarizer 210 and the second polarizer 211 of the liquid crystal display panel 2 is defined in accordance with a direction of the ridge lines of the prisms 51 in the prism sheet 50 which forms the illuminating device 1. More specifically, the absorption axis of the second polarizer 211 of the liquid crystal display panel 2 disposed on a side of the illuminating device 1 is oriented to a direction in parallel with the direction of the ridge lines of the prisms 51 in a planar view, whereas, the absorption axis of the first polarizer 210 disposed on an opposite side of the illuminating device 1 is oriented to a direction orthogonal to the direction of the ridge lines of the prisms 51.

In the above-mentioned configuration, the light output from the illuminating device 1 irradiates the liquid crystal display panel 2. The light, which irradiates the liquid display panel 2 and passes through the second polarizer 211, is made incident on the first polarizer 210 after passing through the liquid crystal layer 200. At this time, the direction of the liquid crystal molecules may be changed when an electric field corresponding to image information that is received from an image information generation unit (not shown) is applied to the liquid crystal layer. Accordingly, the polarization state of the light which passes through the liquid crystal layer 200 is changed and an amount of light passing through the first polarizer 210 is controlled, to thereby display an image corresponding to image information that is input from outside.

Light output from the illuminating device 1, as described above, is light which has a polarization plane of the electric vector in a direction orthogonal to the direction of the ridge lines of the prisms 51 in the prism sheet 50 which forms the illuminating device 1, and contains a higher ratio of linearly polarized light (p-polarized light). Accordingly, when the absorption axis of the second polarizer 211 of the liquid crystal display panel 2, which is disposed on the illuminating device 1, is made in parallel with the direction of the ridge lines of the prisms 51 as described above, the amount of light which is absorbed by the second polarizer 211 to be a loss may be decreased. In other words, the transmittance of the liquid crystal display panel 2 is increased with respect to the light output from the illuminating device 1, and hence an effect of producing brighter image display may be realized. Further, electric power of the illuminating device (backlight) may be saved because of the increase in transmittance when the image is displayed with the same brightness.

While there have been described what are at present considered to be certain embodiments of the invention, it is understood that various modifications may be made thereto, and it is intended that the appended claims cover all such modifications as fall within the true spirit and scope of the invention.

What is claimed is:

1. An illuminating device, comprising:
a light source;
a light guide plate received a light from the light source at a side surface of the light guide plate and outputting from a front surface of the light guide plate; and
a reflector disposed on a rear surface side of the light guide plate,
wherein the light guide plate outputs light so that the light has a peak of one of a luminance and luminous intensity at an output angle inclined with respect to a normal line of the front surface,
wherein the light guide plate has a birefringence, and
wherein a part of the light output at the output angle is made obliquely incident on the front surface at an angle smaller than a critical angle on the front surface of the light guide plate to be reflected in the light guide plate and, then, when the part of the light travels to the rear surface side and is reflected on the rear surface side of the light guide plate and on the reflector to return to the front surface, the part of the light has polarized light components converted so that the part of the light contains more p-polarized light components than s-polarized light components, and the part of the light is output from the front surface.

2. The illuminating device according to claim 1,
wherein the reflector comprises a reflective member,
wherein the light guide plate and the reflective member has a transparent medium formed so as to be interposed therebetween, and
wherein the light guide plate has a birefringence according to a thickness and a refractive index of the transparent medium.

3. The illuminating device according to claim 2, wherein the transparent medium comprises a transparent member having a refractive index lower than a refractive index of the light guide plate and higher than a refractive index of air.

4. The illuminating device according to claim 3, wherein the refractive index of the transparent member is 1.3 or more to 1.45 or less.

5. The illuminating device according to claim 2,
wherein the light source contains light with a wavelength of λ, and
wherein the light guide plate has an optical anisotropy, and has the birefringence set so that an angle θ formed between a slow axis of the light guide plate and a longitudinal direction of the side surface having the light source of the light guide plate disposed therein is larger than 45 degrees or that a phase difference R of the light guide plate is larger than λ/4.

6. The illuminating device according to claim 4,
wherein the light source contains light with a wavelength of λ, and
wherein the light guide plate has an optical anisotropy, an angle θ formed between a slow axis of the light guide plate and a longitudinal direction of the side surface having the light source of the light guide plate disposed therein is 44°≦θ≦59°, and a phase difference R of the light guide plate satisfies λ/4×0.98≦R≦λ/4×1.08.

7. The illuminating device according to claim 6, wherein the light guide plate is configured so that an angle θ formed between the slow axis of the light guide plate and a longitudinal direction of the side surface having the light source of the light guide plate disposed therein is 50°≦θ≦53°, and the phase difference R of the light guide plate satisfies λ/4×1.025≦R≦λ/4×1.033.

8. The illuminating device according to claim 2,
wherein the transparent medium comprises air having a refractive index of about 1.0, and
wherein the reflective member and the rear surface of the light guide plate have a space formed therebetween by the transparent medium.

9. The illuminating device according to claim 8, wherein the space has a thickness of 50 nm or more to 240 nm or less.

10. The illuminating device according to claim 9,
wherein the light source contains light with a wavelength of λ, and
wherein the light guide plate has a uniaxial anisotropy, an angle θ formed between a slow axis of the light guide plate and a longitudinal direction of the side surface having the light source of the light guide plate disposed therein is 64°≦θ≦71°, and a phase difference R of the light guide plate satisfies λ/4×1.35≦R≦λ/4×1.75.

11. The illuminating device according to claim 8,
wherein the plurality of inclined surface portions are formed into concave shapes from the rear surface of the light guide plate,
wherein at least one spacer is formed on the rear surface of the light guide plate so as to maintain the space between the light guide plate and the reflective member, and
wherein the spacer is disposed adjacent to one of the plurality of inclined surface portions and on a side opposite to a side having the light source disposed thereon with respect to the inclined surface portion.

12. The illuminating device according to claim 8,
wherein the plurality of inclined surface portions are formed into convex shapes from the rear surface of the light guide plate,
wherein at least one spacer is formed on the rear surface of the light guide plate so as to maintain the space between the light guide plate and the reflective member, and
wherein the spacer is disposed adjacent to one of the plurality of inclined surface portions and on a side having the light source disposed thereon with respect to the inclined surface portion.

13. The illuminating device according to claim 2, wherein the reflector comprises a reflective member contacted to the rear surface of the light guide plate.

14. The illuminating device according to claim 8, wherein the space has a thickness of 30 nm or less.

15. The illuminating device according to claim 13,
wherein the light source contains light with a wavelength of λ, and
wherein the light guide plate has a uniaxial anisotropy, an angle θ formed between a slow axis of the light guide plate and a longitudinal direction of the side surface having the light source of the light guide plate disposed therein is 43°≦θ≦60°, and a phase difference R of the light guide plate satisfies λ/4×0.9≦R≦λ/4×1.2.

16. The illuminating device according to claim 15, wherein the light guide plate is configured so that the angle θ formed between the slow axis of the light guide plate and the longitudinal direction of the side surface having the light source of the light guide plate disposed therein is 50°≦θ≦54°, and the phase difference R of the light guide plate satisfies λ/4×0.96≦R≦λ/4×1.08.

17. The illuminating device according to claim 1,
wherein the light guide plate comprises:
a thin plate-shaped transparent medium having a birefringence;
and a high refractive index material having a refractive index higher than a refractive index of the transparent medium, and
wherein the front surface of the light guide plate is configured by forming the high refractive index material into a layer shape on the thin plate-shaped transparent medium.

18. The illuminating device according to claim 17,
wherein the light source contains light with a wavelength of λ, and
wherein the high refractive index material has a thickness and a refractive index according to the light with the wavelength of λ output at the output angle from the front surface of the light guide plate.

19. The illuminating device according to claim 1,
wherein the illuminating device further comprises an optical sheet disposed on the front surface side of the light guide plate,
wherein the optical sheet includes a base material formed of a transparent medium generating no phase difference for p-polarized light output from the light guide plate at the output angle to be made incident on a surface on the light guide plate side at a predetermined incident angle, and
wherein one of the surface of the optical sheet on the light guide plate side and a surface on an opposite side of the light guide plate includes a prism array having at least two inclined surfaces and a ridge line parallel to a longitudinal direction of the side surface having the light source of the light guide plate disposed therein.

20. The illuminating device according to claim 19,
wherein the optical sheet includes the prism array disposed on the surface on the opposite side of the light guide plate, and
wherein the surface of the base material on the light guide plate side includes s-polarized light high reflecting means for increasing, for light output from the light guide plate to be made incident on the surface on the light guide plate side at a predetermined angle, a ratio of the p-polarized light components of the light transmitted through the optical sheet by reflecting the s-polarized light components of the light.

21. A liquid crystal display device comprising:
an illuminating device; and
a liquid crystal display panel for displaying an image by controlling a transmission of light from the illuminating device,
wherein the illuminating device comprises:
a light source;
a light guide plate received a light from the light source at a side surface of the light guide plate and outputting from a front surface of the light guide plate; and a reflector disposed on a rear surface side of the light guide plate,
wherein the light guide plate outputs light so as to have a peak of one of a luminance and luminous intensity at an output angle inclined by a predetermined angle with respect to a normal line of the front surface,
wherein the light guide plate has a birefringence,
wherein a part of the light output at the output angle is made obliquely incident on the front surface at an angle smaller than a critical angle on the front surface of the light guide plate to be reflected in the light guide plate and, then, when the part of the light obliquely travels from the front surface through the light guide plate via the reflector to return, polarized light components are converted so as to contain more p-polarized light components than s-polarized light components, and the part of the light is output from the front surface at the output angle, and
wherein the liquid crystal display panel comprises a polarizer disposed on the illuminating device side, the polarizer having a transmission axis provided in parallel to the p-polarized light components of the light output at the output angle.
